(19) United States
(12) Patent Application Publication
(10) Pub. No.: US 2026/0040135 A1
(43) Pub. Date: Feb. 5, 2026

(54) REPORTING DATA CONDITIONALLY AVAILABLE FOR TRANSMISSION

(71) Applicant: InterDigital Patent Holdings, Inc., Wilmington, DE (US)

(72) Inventors: Tejaswinee Lutchoomun, Montreal (CA); Ghyslain Pelletier, Montreal (CA)

(73) Assignee: InterDigital Patent Holdings, Inc., Wilmington, DE (US)

(21) Appl. No.: 18/794,711

(22) Filed: Aug. 5, 2024

(51) Int. Cl. H04W 28/02

(52) U.S. Cl. CPC H04W 28/0268; H04W 28/0278

(57) ABSTRACT

A device (e.g., wireless transmit/receive unit (WTRU)) may report data conditionally available for transmission. A device may determine an association between first data and second data, determine (e.g., based on the association between the first data and the second data) at least one triggering condition (e.g., a transmission availability of the first data) for reporting scheduling information associated with the second data, and report the scheduling information associated with the second data based on the satisfaction of the triggering condition. The scheduling information associated with the second data may be indicated in a buffer status report (BSR), a delay status report (DSR), or a scheduling request (SR). The satisfaction of the triggering condition for reporting the scheduling information associated with the second data may be determined at a medium access control (MAC) layer, a radio link control (RLC) layer, or a packet data convergence protocol (PDCP) layer of the WTRU.

### BACKGROUND

Mobile communications using wireless communication continue to evolve. A fifth generation may be referred to as 5G. A previous (legacy) generation of mobile communication may be, for example, fourth generation (4G) long term evolution (LTE).

### SUMMARY

Systems, methods, and instrumentalities are described herein related to reporting data conditionally available for transmission, e.g., for data streams related to immersive services and/or extended reality (XR). A wireless transmit/receive unit (WTRU) may provide knowledge to a scheduler of granular/dynamic quality of service (QoS) differentiation that may be driven by application awareness. For example, a WTRU may report (e.g., in a buffer status report (BSR)/delay status report (DSR) a differentiation between service levels (e.g., including whether dependent data unit 2 is available for transmission, delay added, packet delay budget (PDB) left, and/or a reason for special treatment). For a data that may have been delayed, the WTRU may send an indication to the network (NW) (e.g., in a BSR or DSR). The indication may include the time the data was “held” in the WTRU buffer. The indication may (e.g., also) include the reason for holding, which may enable the NW (e.g., gNB) to (e.g., still) allocate grants for data, even if the data is being held. For example, the gNB may provide resources to a higher prioritized bit rate (PBR). The WTRU may (e.g., also) report on different time criticality, which may be dependent on the WTRU identifying whether there is a baseline data volume to be transmitted and/or an “enhanced” data volume to be transmitted, e.g., including data being “held” and/or based on a forward error correction (FEC) ratio being met.

An example device may include a processor configured to perform one or more actions. For example, a device (e.g., a wireless transmit/receive unit (WTRU)) may (e.g., be configured to) determine an association between first data and second data. The device may determine, based on the association between the first data and the second data, a triggering condition for reporting scheduling information associated with the second data. For example, the triggering condition may be satisfied based on a transmission availability of the first data. The device may report the scheduling information associated with the second data based on the satisfaction of the triggering condition.

In examples, the device may (e.g., further) determine an arrival of the second data (e.g., at a higher layer). The scheduling information may be reported (e.g., further) based on the arrival of the second data.

In examples, the association between the first data and the second data may indicate that the transmission availability of the second data depends on the transmission availability of the first data. For example, the triggering condition may be that the first data is available to be transmitted. The device may determine that the second data is available to be transmitted based on the satisfaction of the triggering condition. The device may report the scheduling information based on the determination that the second data is available to be transmitted.

In examples, the first data may be associated with a source data unit and the second data may be associated with a repair data unit. The device may generate the repair data unit based on the source data unit.

In examples, the triggering condition may be a first triggering condition. The device may determine, based on the association between the first data and the second data, a second triggering condition for reporting the scheduling information associated with the second data. The second triggering condition may be satisfied based on a transmission status of the first data. The scheduling information associated with the second data may be reported (e.g., further) based on the satisfaction of the second triggering condition.

In examples, the device may transmit the first data. The device may receive an indication that the first data is received. The device may determine the transmission status of the first data based on the indication. The transmission status may indicate that the transmission of the first data is successful.

In examples, the first data may be associated with a data unit. The device may receive an indication that a percentage of the data unit is received. The device may determine a third triggering condition for reporting the scheduling information associated with the second data. The third triggering condition may be satisfied based on the percentage of the data unit being greater than a threshold value.

In examples, the scheduling information associated with the second data may be indicated in a buffer status report (BSR), a delay status report (DSR), or a scheduling request (SR).

In examples, the satisfaction of the triggering condition for reporting the scheduling information associated with the second data may be determined at a medium access control (MAC) layer, a radio link control (RLC) layer, or a packet data convergence protocol (PDCP) layer of the WTRU.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

### EXAMPLE NETWORKS FOR IMPLEMENTATION OF THE EMBODIMENTS

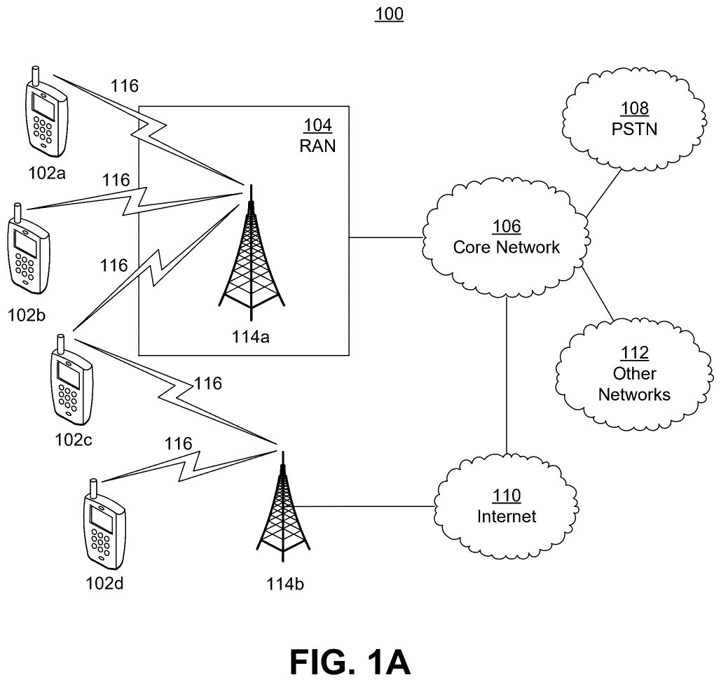

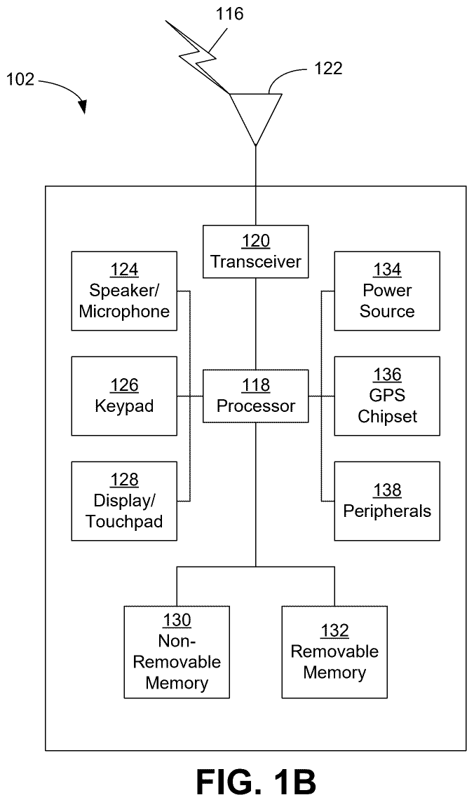

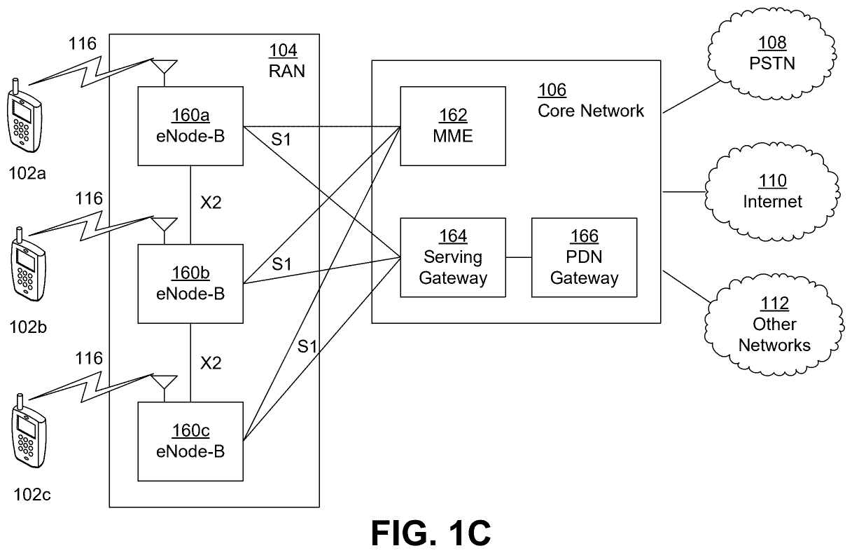

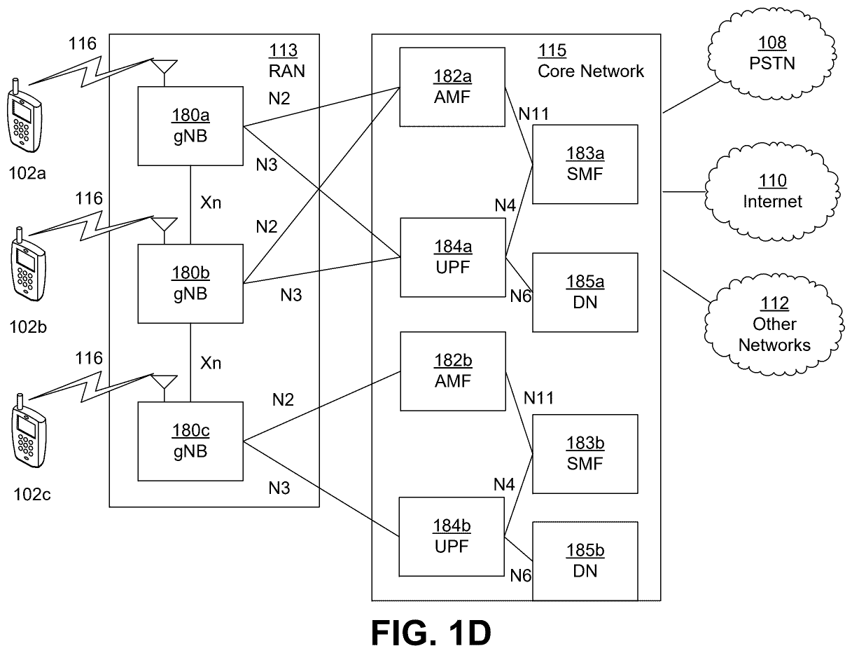

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHZ, 80 MHZ, and/or 160 MHz wide channels. The 40 MHZ, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHZ, 2 MHZ, 4 MHZ, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHZ, 16 MHZ, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 182 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Systems, methods, and instrumentalities are described herein related to reporting data conditionally available for transmission, e.g., for data streams related to immersive services and/or extended reality (XR). A wireless transmit/receive unit (WTRU) may provide knowledge to a scheduler of granular/dynamic quality of service (QoS) differentiation that may be driven by application awareness. For example, a WTRU may report (e.g., in a buffer status report (BSR)/delay status report (DSR) a differentiation between service levels (e.g., including whether dependent data unit 2 is available for transmission, delay added, packet delay budget (PDB) left, and/or a reason for special treatment). For a data that may have been delayed, the WTRU may send an indication to the network (NW) (e.g., in a BSR or DSR). The indication may include the time the data was “held” in the WTRU buffer. The indication may (e.g., also) include the reason for holding, which may enable the NW (e.g., gNB) to (e.g., still) allocate grants for data, even if the data is being held. For example, the gNB may provide resources to a higher prioritized bit rate (PBR). The WTRU may (e.g., also) report on different time criticality, which may be dependent on the WTRU identifying whether there is a baseline data volume to be transmitted and/or an “enhanced” data volume to be transmitted, e.g., including data being “held” and/or based on a forward error correction (FEC) ratio being met.

An example device may include a processor configured to perform one or more actions. For example, a device (e.g., a wireless transmit/receive unit (WTRU)) may (e.g., be configured to) determine an association between first data and second data. The device may determine, based on the association between the first data and the second data, a triggering condition for reporting scheduling information associated with the second data. The triggering condition may be satisfied based on a transmission availability of the first data. The device may report the scheduling information associated with the second data based on the satisfaction of the triggering condition.

In examples, the device may (e.g., further) determine an arrival of the second data (e.g., at a higher layer). The scheduling information may be reported (e.g., further) based on the arrival of the second data.

In examples, the association between the first data and the second data may indicate that the transmission availability of the second data depends on the transmission availability of the first data. For example, the triggering condition may be that the first data is available to be transmitted. The device may determine that the second data is available to be transmitted based on the satisfaction of the triggering condition. The device may report the scheduling information based on the determination that the second data is available to be transmitted.

In examples, the first data may be associated with a source data unit and the second data may be associated with a repair data unit. The device may generate the repair data unit based on the source data unit.

In examples, the triggering condition may be a first triggering condition. The device may determine, based on the association between the first data and the second data, a second triggering condition for reporting the scheduling information associated with the second data. The second triggering condition may be satisfied based on a transmission status of the first data. The scheduling information associated with the second data may be reported (e.g., further) based on the satisfaction of the second triggering condition.

In examples, the device may transmit the first data. The device may receive an indication that the first data is received. The device may determine the transmission status of the first data based on the indication. The transmission status may indicate that the transmission of the first data is successful.

In examples, the first data may be associated with a data unit. The device may receive an indication that a percentage of the data unit is received. The device may determine a third triggering condition for reporting the scheduling information associated with the second data. The third triggering condition may be satisfied based on the percentage of the data unit being greater than a threshold value.

In examples, the scheduling information associated with the second data may be indicated in a buffer status report (BSR), a delay status report (DSR), or a scheduling request (SR).

In examples, the satisfaction of the triggering condition for reporting the scheduling information associated with the second data may be determined at a medium access control (MAC) layer, a radio link control (RLC) layer, or a packet data convergence protocol (PDCP) layer of the WTRU.

Wireless system transport data streams may be associated with different services and/or applications. Data may be transported as different flows. A (e.g., each) service and/or application may transmit data associated with a plurality of flows. A (e.g., each) flow may be associated with a (e.g., specific) Quality of Service (QoS). Data units for different applications may be assigned to different flows or grouped together, e.g., according to different strategies. For example, video may be coded as base layer and enhancement layer. Different data units may represent different type of information for the decoding process (e.g., I-frame, B-frame, P-frames) and/or may represent different areas of the field of view (FoV) for a given user, for example. Applications may (e.g., further) use forward error correction (application layer forward error correction (AL-FEC)), for example, such that additional repair data may be available at the receiver, e.g., if needed, such as if/when a data unit may be lost or delayed beyond an acceptable amount of time at some point in the transmission path between transmitter and sender. Different AL-FEC algorithms may implement different strategies, for example, as described herein.

Data units from a given service and/or given application may be differentiated, for example, in terms of their impact to the quality of service (QoS) and/or quality of experience (QoE) of the end user. An impact may vary over time and/or may be dependent on the reception status of other, e.g., related, data units.

Data streams may be related to immersive services and/or extended Reality (XR). The term extended Reality (XR) may be an umbrella term for different types of immersive experiences, including, for example, Virtual Reality (VR), Augmented Reality (AR), Mixed Reality (MR), and the realities interpolated among the various types of immersive experiences. Virtual Reality (VR) may be a rendered version of a delivered visual and/or audio scene. A rendering may be designed to mimic the visual (e.g., stereoscopic 3D) and/or audio sensory stimuli of the real world (e.g., as naturally as possible) to an observer or user as the observer or user moves within the limits defined by the application. Augmented Reality (AR) may be when a user is provided with additional information, artificially generated objects/items, and/or content overlaid upon their current environment. Mixed Reality (MR) may be an advanced form of AR where, for example, one or more virtual elements may be inserted into the physical scene, e.g., with the intent to provide the illusion that the elements are part of the real scene. XR may include (e.g., all) real-and-virtual combined environments and/or human-machine interactions generated by computer technology and wearables. The notion of immersion in the context of XR applications/services may refer to the sense of being surrounded by a virtual environment and/or providing the feeling of being physically and/or spatially located in the virtual environment. The levels of virtuality may range from partial sensory inputs to fully immersive multi-sensory inputs, which may lead to a virtual reality practically indiscernible from actual reality.

Traffic (e.g., in XR services and applications) may include data/protocol data units (PDUs), which may be associated with an application data unit (ADU), PDU set, or data burst. In an example, the PDUs belonging to a PDU set may be associated with different segments or components of a video frame or a video slice. A data burst may include one or more PDU sets that may be transmitted/received over a time window. For example, a number of PDUs in an PDU set or data burst transmitted in uplink (UL) and/or received in downlink (DL) may be dependent on the type of the media frame (e.g., 3D video frame, audio frame).

A WTRU (e.g., executing an XR application) may transmit XR traffic, which may include one or more PDUs/PDU sets in UL (e.g., pose, gesture, video data), and/or may receive XR traffic in DL (e.g., video, audio, haptics). Traffic may be transmitted and/or received periodically or aperiodically in one or more data flows (e.g., QoS flows). During UL transmissions, XR traffic may arrive from the application layer at a WTRU and/or from different devices/terminals/WTRUs (e.g., via sidelink, WiFi, or wired connection) at different time instances. XR traffic may be characterized by different attributes, such as variable payload sizes per PDU set, variable number of PDUs per PDU set, variable per-PDU/PDU set level importance, and/or different levels of inter-dependencies between PDUs/PDUs sets. XR traffic (e.g., PDU/PDU sets) received by a WTRU may (e.g., also) experience different delays, jitter, data rate, and/or loss rate. A QoS and/or high user experience (e.g., QoE) may be provided, for example, by performing data transmission/reception and/or other associated functions (e.g., prioritization, multiplexing, scheduling) on timely basis with XR awareness (e.g., awareness of PDU set attributes).

Application layer Forward Error Correction (AL-FEC) may be implemented. There may be different types of data output from an AL-FEC process, for example, depending on the encoding scheme at the codec.

For example, an FEC encoder may encode one or more data units and/or may output N coded data units, e.g., where any K coded data units out of N may be sufficient to successfully decode the initial data unit(s). N, and/or K may represent an equal or larger number than the number of data units used as input to the encoding process. N−K data units may (e.g., thus) be available to compensate, for example, if/when fewer than K coded data units are received at the receiver.

For example, K coded data units may be source PDUs. For example, N−K coded data units may be repair PDUs.

An application may generate data units that may be used as enhancement and/or mitigation of error propagation at the receiver.

There may be multiple application data types. Multiple AL-FEC data types may be described herein, which may be referred to as a data packet or PDU of the AL-FEC process. A packet/PDU type may refer, for example, to any one or more of the following: a source PDU, a repair PDU, and/or an enhancement PDU.

A source PDU may include a data unit. An application may successfully recover the initial application data, for example, if/when all source PDUs are received. For example, source PDUs may be used for successful decoding of application level data.

A repair PDU may be generated from a source PDU. A repair PDU may be used to reconstruct a source PDU. One or more repair PDU(s) may be considered redundant information, for example, if the corresponding source PDU(s) are received by the receiving application and/or if the repairs PDU(s) included application data that has been successfully decoded from the transmission of other PDUs (e.g., source PDUs).

An enhancement PDU may provide (e.g., additional) application-level information. A higher QoS and/or QoE may be achieved, for example, if/when enhancement PDU data is received by the application. An enhancement PDU may provide (e.g., to an application) error propagation mitigation, error concealment, and/or error recovery capabilities. An enhancement PDU may be generated (e.g., directly), for example, from an application encoding (e.g., video coded enhancement layer), from the one or more application level data units used as input to the AL-FEC encoding, or from source and/or repair PDUs. For example, an enhancement PDU may not be considered as critical (e.g., or mandatory) because the receiver may (e.g., be able to) determine/predict a missing enhancement PDU from another PDU (e.g., a source PDU). For example, a video frame delivered without any enhancement PDUs may still be considered as successfully delivered.

There may be dependencies between data units. For example, there may be dependencies between source and repair data units.

A repair data unit may be generated from a source data unit. The source:repair dependencies between the repair data unit and the source data unit may be characterized, for example, in any one or more of the following ways: 1:1; 1:1 but not every source packet may generate a repair packet; 1:M; and/or M:1.

A source:repair dependency between the repair data unit and the source data unit may be characterized as 1:1. For example (e.g., in a 1:1 dependency), every source packet may generate a repair packet. For example (e.g., in a 1:1 dependency), there may exist a (e.g., direct) dependency between the source packet and the repair packet generated from the source packet.

A source:repair dependency between the repair data unit and the source data unit may be characterized as 1:1, but not every source packet may generate a repair packet. For example, a source packet may generate a repair packet. For example, a repair packet may be used to reconstruct the source packet it was generated from. For example, a repair packet may be used to reconstruct another source packet that it was not generated from, e.g., a source packet that is adjacent to the source packet it was generated from.

A source:repair dependency between the repair data unit and the source data unit may be characterized as 1:M. For example (e.g., in a 1:M dependency), a source packet may generate multiple repair packets. For example, one or more repair packets may be used to reconstruct the source packet. For example, multiple repair packets may be used to reconstruct the source packet.

A source:repair dependency between the repair data unit and the source data unit may be characterized as M:1. For example, several source packets may be used to generate a repair packet. For example, the repair packet may be used to reconstruct any one or more of the source packets used to generate the repair packet.

Dependencies may be visible at the application in the WTRU. Dependency information may be available to the data transmission process in a transmitting device (e.g., a WTRU). For example, the WTRU (e.g., lower layers) may receive an indication of dependencies from the application layer.

There may be dependencies between source and enhancement data units. An enhancement data unit may be generated from a source and/or a repair data unit. Enhancement dependencies between the source and/or repair data unit and the enhancement data unit may be characterized, for example, in any one or more of the following ways: 1:1; 1:1 but not every source and/or repair packet may generate an enhancement packet; 1:M; and/or M:1.

Enhancement dependencies between the source and/or repair data unit and the enhancement data unit may be characterized as 1:1. For example (e.g., in a 1:1 dependency), every source and/or repair packet may generate an enhancement packet. For example, there may exist a (e.g., direct) dependency between the source and/or repair packet and the enhancement packet generated from the source and/or repair packet.

Enhancement dependencies between the source and/or repair data unit and the enhancement data unit may be characterized as 1:1, but not every source and/or repair packet may generate an enhancement packet. For example, a source and/or repair packet may generate an enhancement packet. For example, an enhancement packet may be used to reconstruct the source and/or repair packet the enhancement packet was generated from. For example, an enhancement packet may be used to reconstruct another source and/or repair packet that the enhancement packet was not generated from, e.g., a source and/or repair packet that is adjacent to the source and/or repair packet it was generated from.

Enhancement dependencies between the source and/or repair data unit and the enhancement data unit may be characterized as 1:M. For example, a source and/or repair packet may generate multiple enhancement packets. For example, one or more enhancement packet(s) may be used to reconstruct the source and/or repair packet. For example, multiple enhancement packets may be used to reconstruct the source and/or repair packet.

Enhancement dependencies between the source and/or repair data unit and the enhancement data unit may be characterized as M:1. For example, several source and/or repair packets may be used to generate an enhancement packet. For example, the enhancement packet may be used to reconstruct any one or more of the source and/or repair packet(s) used to generate the enhancement packet.

Dependencies may be visible at the application in the WTRU. Dependency information may be available to the data transmission process in a transmitting device (e.g., a WTRU). For example, the WTRU (e.g., lower layers) may receive an indication of dependencies from the application layer.

Repair PDUs may be generated from the source PDUs, e.g., according to the FEC algorithm. The repair PDUs may help in the detection and/or correction of errors in the traffic stream. Repair PDUs may not be needed by the receiver, for example, if the receiver successfully receives all the source PDUs and they are all uncorrupted. However, if the receiver does not successfully receive any/some/all source PDUs, then the receiver may use the repair PDUs to recover the information that was included in the source PDUs that were not successfully received.

Packetization may be implemented. Applying any FEC algorithm may result in, for example, one or more of the following packetization options: data of different types ending up in different data units (e.g., one data unit including only source packets, another data unit including only repair packets) and/or data of different types ending up in the same data unit (e.g., one data unit including a ratio of two of more data units or type thereof).

A WTRU supporting an XR experience may be receiving data units (e.g., PDUs, PDU sets, data bursts, bitstreams) from higher layers or different devices, such as AR glasses and haptics gloves (e.g., via SL). The data units, which may have variable payload sizes, different periodicity, jitter, and/or different inter-dependencies, may be (e.g., further) processed and transmitted by the WTRU in the UL.

Operations related to capacity may include, for example, one or more of the following: multiple Configured Grant (CG) physical uplink shared channel (PUSCH) transmission occasions in a period of a single CG PUSCH configuration; dynamic indication of unused CG PUSCH occasion(s) based on Uplink Control Information (UCI) by the WTRU; buffer status report (BSR) including buffer status report (BSR) Table(s); delay reporting of buffered data in uplink; and/or discard operation of PDU Sets for UL.

Operations related to power savings may include, for example, one or more of the following: discontinuous reception (DRX) support of XR frame rates corresponding to non-integer periodicities (e.g., through at least semi-static mechanisms, such as RRC signaling).

Operations related to XR awareness may include, for example, one or more of the following: in the downlink, signaling by CN of semi-static information per QoS flow (e.g., PDU set QoS parameters), dynamic information per PDU set (PDU Set information and Identification), and/or End of Data Burst indication, and/or in the uplink, provisioning by WTRU of XR traffic assistance information, e.g., periodicity, UL traffic arrival information.

A Data Volume Calculation may be performed. In example wireless systems, a WTRU may determine the amount of data available for transmission, e.g., for the purpose of MAC buffer status reporting (BSR) and/or for the purpose of MAC delay status reporting (DSR). The WTRU may calculate the RLC data volume and/or the packet data convergence protocol (PDCP) data volume.

The RLC data volume for BSR may include, for example, one or more of the following: RLC SDUs and RLC SDU segments that may not have been included in an RLC data PDU; RLC data PDUs that may be pending for initial transmission; and/or RLC data PDUs that may be pending for retransmission (RLC AM).

The PDCP data volume for BSR may include, for example, one or more of the following: the PDCP service data units (SDUs) for which PDCP Data PDUs may not have been constructed; the PDCP Data PDUs that may not have been submitted to lower layers; the PDCP Control PDUs; for AM DRBs, the PDCP SDUs to be retransmitted; and/or for AM DRBs, the PDCP Data PDUs to be retransmitted.

The combined logic may ensure that a control plane or user plane data unit (e.g., IP packet) is reported once (e.g., not reported twice) for each layer, e.g., as a function of the unit's processing state. The combined logic may (e.g., also) consider that any data that is considered under processing (e.g., by PDCP or RLC) may be reported in the BSR.

The PDCP data volume for DSR may include one or more of the following in a delay-critical PDCP data volume. The transmitting PDCP entity may, for example (e.g., for the purpose of MAC delay status reporting), consider one or more of the following as a delay-critical PDCP data volume: the delay-critical PDCP SDUs for which PDCP Data PDUs may not have been constructed; the PDCP Data PDUs that may include the delay-critical PDCP SDUs that may not have been submitted to lower layers; the PDCP Control PDUs; for AM DRBs, the PDCP SDUs to be retransmitted (e.g., as may be described herein); for AM DRBs, the PDCP Data PDUs to be retransmitted (e.g., as may be described herein).

A PDCP may indicate to a lower layer (e.g., if/when a PDCP SDU becomes delay critical) whether/if a corresponding PDCP Data PDU has been submitted to lower layers.

The RLC data volume for DSR may include, for example, one or more of the following in a delay-critical RLC data volume: delay-critical RLC SDUs and delay-critical RLC SDU segments that may not have been included in an RLC data PDU; RLC data PDUs pending for initial transmission, which may include a delay-critical RLC SDU or a delay-critical RLC SDU segment; RLC data PDUs that may be pending for retransmission (RLC AM).

The combined logic may ensure that the a control plane or user plane data unit (e.g., IP packet) is reported once (e.g., not reported twice) for each layer, e.g., as a function of the unit's processing state and/or contents. The combined logic may (e.g., also) consider that any data that may be considered under processing (e.g., by PDCP or RLC) that may be delay critical may be reported in the DSR. The combined logic may (e.g., also) consider as delay critical data units that may be retransmitted or pending retransmission.

Logical Channel Prioritization may be applied. In examples of current wireless systems, a logical channel prioritization (LCP) procedure may be applied, for example, if/when a new transmission is performed.

A WTRU may determine what data units to multiplex in a transport block for uplink transmission, for example, by (e.g., first) selecting the logical channels applicable to the new transmission according to one or more conditions (e.g., also referred to as “mapping restrictions”), which may include, for example, if data associated with a logical channel can be transmitted with respect to a configured restriction, such as the allowed subcarrier spacing, the PUSCH transmission duration, the type of configured grant, the allowed serving cell, the allowed cell group, the priority index associated with the dynamic UL grant and the allowed hybrid automatic repeat request (HARQ) mode, etc. A WTRU may select the logical channel (LCH) for the next step of the logical channel prioritization (LCP) procedure, for example, if a logical channel's configuration allows associated data be included in the transport block associated with the transmission resources. RRC may control the conditions, for example, by configuration of the MAC parameters, LCH configuration, and/or logical channel group (LCG) configuration.

A WTRU may multiplex data from a selected LCH(s), for example, in decreasing priority order, e.g., where data amount from each LCH may be multiplexed up to their Bj value, which value may be based on the LCH's configured Prioritized Bit Rate (PBR) and/or Bucket Size Duration (BSD). For example, Bj may be equal to PBR multiplied by BSD (e.g., Bj=PBR×BSD). Bj may be decremented by the total size of data multiplexed.

The WTRU may (e.g., if any resource remains) multiplex data from a selected LCH(s) (e.g., in decreasing priority order), regardless of the value Bj, for example, until (e.g., all) the data for the LCH is exhausted or until the resources of the grant are exhausted. LCHs of equal priority may be served equally.

A PDU set may be composed of one or more PDUs carrying the payload of a (e.g., one) unit of information generated at the application level (e.g., a frame or video slice for XRM Services). In some examples, (e.g., all) the PDUs in a PDU Set may be utilized by the application layer to use the corresponding unit of information. In some examples, the application layer may recover one or more parts or all or of the information unit if/when one or more PDUs are missing. For the uplink, the identification of PDU sets, data bursts, and/or PDU Set Importance (PSI) may be left to WTRU implementation.

For a PDU Set in a QoS flow for which the PDU set Integral handling indication (PSIHI) is set, one or more (e.g., all) remaining PDUs of the PDU Set may be discarded at the transmitter (e.g., to free up radio resources), for example, if/when a (e.g., one) PDU of the PDU set is known to be lost or associated with a discarded SDU.

PDU Set Delay Budget (PSDB) may be the time between reception of the first PDU (e.g., at the UPF in DL, at the WTRU in UL) and the successful delivery of the last arrived PDU of a PDU Set (e.g., at the WTRU in DL, at the UPF in UL). PSDB may be an optional parameter. The PSDB (e.g., if/when provided) may supersede the PDB.

The semantics of the fields of the real-time transport protocol (RTP) Header Extension for the marking of PDU Set and End of Bursts in the downlink may be defined, for example, based on one or more of the following: the end PDU of a PDU set [E] may be one bit; an End of Data Burst (EDB) may be three (3) bits; PDU Set Importance (PSI) may be four (4) bits; PDU Set Sequence Number (PSSN) may be ten (10) bits; PDU Sequence Number within a PDU Set (PSN) may be six (6) bits; and/or PDU set size (PSSize) may be 24 bits.

An End PDU of the PDU Set [E] field may be a flag that may be set, for example, to one (1) for the last PDU of the PDU Set and/or set to zero (0) for (e.g., all) other PDUs of the PDU Set.

An End of Data Burst (EDB) field may indicate the end of a Data Burst. The (e.g., 3) bits may encode the End of Data Burst indication, e.g., according to encoding and guidelines as may be described herein.

A PDU Set Importance (PSI) field may indicate the importance of the PDU Set compared to other PDU Sets within the same QoS flow. Lower values may indicate a higher importance PDU Set. For example, the highest importance PDU Set may be indicated by zero (0) and the lowest importance PDU Set may be indicated by a higher number (e.g., 15).

A PDU Set Sequence Number (PSSN) field may encode the sequence number of the PDU Set to which the current PDU belongs (e.g., acting as a (10-bit) numerical identifier for the PDU Set).

A PDU Sequence Number within a PDU Set (PSN) may represent the sequence number of the current PDU within the PDU Set. For example, the PSN may be set to zero (0) for the first PDU in the PDU Set and may be incremented (e.g., monotonically) for every PDU in the PDU set in order of transmission from the sender.

A PDU Set Size (PSSize) may indicate the total size of (e.g., all) PDUs of the PDU Set to which the PDU belongs. The PSSize field may be optional. The PSSize field may be subject to an SDP signaling offer/answer negotiation, for example, where the Application Server may indicate whether it will (e.g., be able to) provide the size of the PDU Set for the RTP stream. If not enabled, the PSSize field may not be present. If enabled, but if the Application Server is not able to determine the PDU Size for a particular PDU Set, the PSSize field may set the value (e.g., to zero (0) in (e.g., all) PDUs of the PDU Set. The PSSize may indicate the size of a PDU Set, which may include RTP/UDP/IP header encapsulation overhead of corresponding PDUs. The PSSize may be expressed in bytes.

Traffic of applications (e.g., immersive applications, application-level FEC) may include different types of data units with different characteristics, which may be useful to the application in different ways (e.g., mandatory packets, repair packets, and enhancement packets).

Data units (e.g., IP packets, system data such as for sensing) associated with one (or more) service(s) and/or related to a given user experience may have a different impact on the Quality of Experience, for example, as a function of their respective characteristics e.g., type of information, type of coding method, type of data within the encoded stream(s), impact to rendering of video/audio/sensory/spatial dimensions, and/or the like.

QoS may be same within a DRB. In examples of wireless systems, data associated with a radio bearer (RB) e.g., a data radio bearer (DRB) or a signaling radio bearer (SRB), and/or data associated with a PDU set may be processed using the same QoS functions and parameters with the L2 protocol stack e.g., service data adaptation protocol (SDAP), PDCP, RLC, and/or MAC. For example, two different data units or types thereof with the same QoS (e.g., PSDB) may be treated in the same way in the protocol stack, e.g., even if the data units or types of data units serve different purposes to the application.

Data units (e.g., IP packets, L3/RRC messages) associated with the same radio bearer may receive the same QoS treatment (e.g., prioritization, latency, jitter, guaranteed/prioritized bit rate) while QoS differentiation may be implemented by associating data units to different bearers.

A WTRU may determine when and/or what data is available for transmission. In examples of wireless systems, a WTRU may determine the amount of data available for transmission, e.g., for the purpose of buffer status reporting (BSR). A WTRU may determine when, how much, and/or at what layer data is available for transmission. Different vendors may (e.g., retain the flexibility to) determine (e.g., for WTRU implementation) the processing path and/or timing of IP packets (e.g., SDAP SDUs) down to multiplexing data (e.g., MAC PDU) into a transport block scheduled for uplink transmission. For example, WTRUs may (e.g., variously) implement processing/pre-processing of data units in L2 (e.g., PDCP pre-processing) and/or determine how to manage the corresponding buffers.

WTRU implementations may determine that data units (e.g., IP packets) are available for transmission, for example, no earlier than once the data units occupy space in the WTRU's buffer. WTRUs may (e.g., variously) report an associated amount of data transmit, for example, as a function of the processing status of the data unit (e.g., considering PDCP, RLC and/or MAC overhead).

In examples of wireless systems, a WTRU may determine (e.g., or trigger) the transmission of a buffer status report (BSR), a delay status report (D-SR), and/or a scheduling request (SR), for example, as a function of the data becoming available for transmission, an associated transmission delay requirement, and/or an associated priority.

The triggers to initiate SR, BSR, and/or D-SR may be normatively specified, for example, once data is determined to be available for transmission.

Uplink scheduling information may be conditioned to implement higher granularity (e.g., in terms of QoS differentiation). Uplink scheduling information that may be conditioned may include information related to interdependency between data units, information related to delay-critical data and/or bursts of data that may not yet be available for L2 processing, and/or data that may be generated if a higher level of resources would be available for uplink transmissions.

Conditioning uplink scheduling information for higher granularity may (e.g., further) include providing knowledge to the scheduler of granular/dynamic QoS differentiation that may be driven by application awareness. For example, a WTRU may report (e.g., in a BSR/DSR) differentiation between service levels (e.g., including whether data unit 2, which may have dependencies on data unit 1, is available for transmission, delay added, PBD left, and/or reason(s) for special treatment).

A WTRU may determine that new data (e.g., a second data unit) may be available for transmission as a function of a condition e.g., a dependency to another data unit (e.g., a first data unit). The first data unit may already be available for transmission (e.g., source and repair, media coded base layer). A determination that new data may be available for transmission may (e.g., additionally and/or alternatively) be a function of the transmission status of the first data unit (e.g., all source is successful within time, at least one source is missing after a certain time has elapsed, or based on HARQ processing status).

A WTRU may determine that a second amount of data is available for transmission, for example, as a function of the transmission status of a first amount of data that may have previously been multiplexed in a transport block and/or previously determined to be available for transmission. A WTRU may perform the logic, for example, in MAC, RLC, and/or PDCP.

The WTRU may use the determination to implement a conditional transmission of the second amount of data. A condition on the transmission of a data unit may be useful, for example, if/when transmission resources may be limited, if/when the WTRU may have the capability to determine differentiated QoS requirements at a granularity level beyond a granularity level of differentiated QoS requirements for, for example, IP flows, data bearers (e.g., application-level base layer versus enhancement layer) and/or if/when the second data may provide error correction/error propagation mitigation/error recovery for the application layer (e.g., application-level FEC repair data).

A WTRU may send an indication to the NW for a data that has been delayed. The indication (e.g., in a (e.g., new) BSR, a (e.g., new) DSR) may include, for example, the time the data was “held” in the WTRU buffer. The indication may (e.g., also) include the reason for holding, which may enable the NW (e.g., gNB) to (e.g., still) allocate grants for data, e.g., even if the data is being held. For example, the gNB may provide resources to a higher PBR.

A WTRU may (e.g., also) report on different time criticality, which may be dependent on the WTRU identifying whether there is a baseline data volume to be transmitted and/or an “enhanced” data volume to be transmitted, e.g., including data being “held.”

As described herein, “hold” may be interpreted as the WTRU determining that a data unit in the WTRU's buffer may not be further processed (e.g., by L2) until a condition is met. A determination may be performed in different protocol layers and/or sublayers (e.g., in service data adaptation protocol (SDAP), packet data convergence protocol (PDCP), radio link control (RLC) and/or in medium access control (MAC)). One or more conditions may be applicable to a data unit. Multiple conditions may be determined in the same protocol layer and/or in different protocol layers.

A WTRU may determine that uplink scheduling information may be triggered and/or reported according to at least one of the following quantities: data unconditionally available for further L2 processing and for transmission (e.g., legacy volume); data conditionally available for further L2 processing, but not for transmission until one or more (e.g., all) associated conditions are met; and/or data not yet available for further L2 processing and (e.g., thus) not ready for transmission.

For example, data that may correspond to a base media coding layer may be reported as data unconditionally available while data that may correspond to an enhancement media coding layer may be reported as conditionally available. In some examples, the data corresponding to the enhancement media coding layer may be reported as not yet available, for example, if the data volume corresponds to a higher QoS service level than currently scheduled (e.g., based on configured, observed, and/or scheduled PBR, PDB).

A WTRU may perform one or more actions. For example, a WTRU may determine a trigger to report scheduling information. The WTRU may determine the data to report, the amount of data to report, and/or a time/delay to report. The WTRU may transmit an indication to the NW (e.g., in an SR, BSR, and/or DSR). The indication may include scheduling information, e.g., data available to report, the amount of data to report, time/delay associated with the data, one or more conditions associated with the data (e.g., whether it is available for transmission, one or more dependencies associated with the data, etc.).

A data unit may include, for example, any one or more of the following: an IP packet and/or a system data unit (e.g., sensing, positioning and/or computing data); a bit and/or group thereof; bytes and/or group thereof; PDU segment and/or group thereof; a PDU; a group/set of PDUs (e.g., PDU set); a set of PDUs that may be considered as one unit at the application, e.g., set of PDUs corresponding to a frame; a group of PDU sets; a data burst; a group of data bursts; a flow; a group of flows; etc.

As described herein, a “data unit” may refer to one data unit, a group of data units, a component of a data unit (e.g., a portion of one data unit), and/or a type of data unit (e.g., a group of one or more data units of one type).

In some examples, a data unit may be constructed at the application and sent to the WTRU (e.g., lower layers) as such. In some examples, a data unit may be constructed at the WTRU.

A (e.g., second) data unit may be (e.g., further) characterized, for example, according to at least one of the following: a QoE level, category, and/or priority; sequencing information; and/or timing information.

A (e.g., second) data unit may be characterized according to QoE level, category and/or priority. A characterization according to QoE level, category, and/or priority may be, for example, an indication of the possible impact of the second data unit to the end-user experience. For example, a higher priority may inform of a higher negative impact if the QoS (e.g., delay, jitter, packet loss rate) is not met for the category. A characterization according to QoE level, category and/or priority may be, for example, an indication that may (e.g., implicitly) be considered as a dependency. For example, a lower priority may inform that the application may tolerate loss, unsuccessful, or no attempt at transmitting the second data unit given that a first data unit of a higher priority may not have been initiated, ongoing, successful, and/or completed.

A (e.g., second) data unit may be characterized according to sequencing information. A characterization according to sequencing information may represent and/or identify a first data unit within a sequence that may be considered as a dependency. For example, the sequencing may inform that the application may tolerate loss, unsuccessful, or no attempt at transmitting the second data unit given that at least one second data unit corresponding to the sequencing information (e.g., equal and/or of earlier position in the sequence) may not have been initiated, ongoing, successful, and/or completed.

A (e.g., second) data unit may be characterized according to timing information. A characterization according to timing information may represent and/or identify a first data unit within a period, a window, and/or a delay bound that may be considered as a dependency. For example, the timing may inform that the application may tolerate loss, unsuccessful, or no attempt at transmitting the second data unit given that at least one second data unit corresponding to the timing information (e.g., earlier in time and/or latency budget) may not have been initiated, ongoing, successful, and/or completed.

There may be IDs/identifiers associated with a data unit and/or component/group/type thereof.

In some examples, the IDs may be allocated by the application.

In some examples, the IDs may be allocated by the WTRU, for example, according to any one or more of the following: using existing identifiers, such as sequence numbering at PDCP; updating existing identifiers, such as sequence numbering at PDCP, to incorporate the concept of data units (e.g., sequence numbering (1,1), (1,2), (1,3) at PDCP referring to packets 1, 2, 3 of data unit 1); using new identifiers allowing the transmitter and receiver to exchange feedback on the data units; the WTRU may receive rules on how to allocate identifiers to the data units and/or identifier or data constituents from the network, e.g., during RRC (re) configuration; and/or the WTRU may receive rules/configuration, e.g., during RRC (re) configuration, on how to translate identifiers for the data units and/or identifier or data constituents that may have been allocated/received (e.g., from a higher/application layer) to an identifier that is understandable to/decodable by the network. For example, a WTRU may receive rules on how to create an identifier. For example, a WTRU may receive a mapping table on how to map an application-created identifier to an identifier that the network understands. For example, a WTRU may receive rules on how to update an identifier.

In some examples, feedback from the network on the successful and/or unsuccessful reception of data unit(s) and/or components thereof may include the identifier of the data units and/or components thereof.

Data units, e.g., as described herein, may refer to a data unit and/or a component/group/type thereof. Data unit(s) may be interchangeably referred to herein as “data.”

A dependent data unit and/or group/component/type thereof, e.g., as described herein, may refer to a data unit and/or group/component/type thereof that may be dependent on another data unit and/or group/component/type thereof or a data unit and/or group/component/type thereof that another data unit and/or group/component/type thereof may be dependent on.

For example, the usefulness of a second data unit, e.g., on the quality of the experience of a given service, may be less (e.g., reduced) if a first data unit is not reliably, timely, and/or previously transmitted.

Data may be grouped as a data unit visible to the WTRU by the application or data may be grouped as a data unit by the WTRU.

In some examples, a data unit may be generated and/or grouped as a (e.g., one) unit of data by the application (e.g., one video frame generated the application) and sent to the WTRU (e.g., lower layers in the WTRU).

In some examples, data may be generated by the application. The WTRU (e.g., SDAP and/or PDCP entity in WTRU) may group the data (e.g., generated by the application) into a data unit. In some examples, the WTRU (e.g., SDAP and/or PDCP entity in WTRU) may see a flow of bits coming in from one or more QoS flows. The WTRU may combine the repair bits into a repair PDU and/or the source bits into a source PDU, which may constitute a data unit. In some examples, the WTRU (e.g., SDAP and/or PDCP entity in WTRU) may combine (e.g., some) source PDUs and corresponding repair PDUs into a (e.g., one) PDU set, which may constitute a data unit. In some examples, the source PDUs assembled/grouped by the WTRU (e.g., SDAP and/or PDCP entity in WTRU) may constitute a primary data unit while the repair PDUs assembled/grouped by the WTRU (e.g., SDAP and/or PDCP entity in WTRU) may constitute a secondary data unit. The WTRU (e.g., SDAP and/or PDCP entity in WTRU) may add markers to the data units that may be read by the receiver (e.g., the gNB) and/or the lower layers in the WTRU (e.g., the MAC entity in the WTRU).

Group of data units (e.g., as described herein) may refer to a group of data units of one type. In some examples, a first group of data unit may refer to a group of mandatory packets while a second group of data units may refer to a group of repair packets. “Data units” (e.g., as described herein) may refer to a group of data units.

Type of data units (e.g., as described herein) may refer to one or more (e.g., any) characteristic of the data unit, e.g., whether attributed by the application and/or the WTRU. Types of data units may include, for example, any one or more of the following: data units associated with a set of QoS parameters, which may include, for example, a type of service, such as a user plane (e.g., IP packets), a control plane (e.g., L3/RRC packets), and/or system data (e.g., sensing, positioning, data collection), a guaranteed bit rate (GBR), a prioritized bit rate (PBR), a transmission delay/latency bound, a transmission jitter bound/range, and/or a packet loss rate (PLR) (e.g., a first type of data units may correspond to a first level of QoS service while a second type of data units may correspond to a second level of QoS service, where the second type of data units may be an enhancement layer of the first type of data units); repair/source/enhancement data units; primary/secondary/tertiary data units; mandatory/non-mandatory data units; needed for QoS and/or QoE enhancement (e.g., repair data units, enhancement data units); not needed for either QoS or QoE enhancement); needed (e.g., only) for QoS enhancement; needed (e.g., only) for QoE enhancement (e.g., an enhancement data unit); low delay budget data units (e.g., PSDB and/or PDU set delay deadline (PSDD) below a certain/threshold value for PDU set); high delay budget data units (e.g., PSDB and/or PSDD below a value for PDU set); low error rate data units (e.g., PER and/or PDU set error rate (PSER) set below a value for PDU set); high error data units (e.g., PSER above a value for PDU set); data units of an importance value or above; data units of an importance value or below; control plane data units; data units for sensing; data units for positioning; system data units; data units pertaining to RF based systems; data units pertaining to non-RF based systems; data units corresponding to an artificial intelligence (AI)/machine learning (ML) system; user plane data; and/or any of the data as may be described herein (e.g., control plane data, sensing data, positioning data, system data, and so on) that may be used by (e.g., critical for) a user plane service to work.

There may be dependencies at lower layers. A second data unit may be dependent on a first data unit, for example, according to at least one of the following: an explicit signaled, configured, and/or specified association (e.g., related to QoE, QoS, sequencing, and/or timing requirements of the first and second data units, respectively); an implicitly determined association (e.g., related to data types (such as a first data unit associated with base QoE level 1 and a second data unit associated with enhanced QoE level 2) and/or scheduling levels (such as whether transmission resources are equal or above QoE level 1); and/or a transmission status of the first data unit (e.g., available for transmission, multiplexed in a TB, initial HARQ transmission, HARQ retransmission, HARQ ACK/transmission completed or HARQ transmission failure/maximum number of HARQ retransmission reached).

For example, there may exist dependencies between data units (e.g., dependencies between a source packet and a repair packet generated from the source packet). At the lower layers, e.g., in the protocol stack (e.g., SDAP, PDCP, RLC, MAC PHY), the dependencies may translate and/or be visible via any one or more of the following: an in-band marking (e.g., in the packet header, such as in SDAP subheader, PDCP subheader, etc.); a separate control data unit (e.g., a separate PDCP control PDU may provide information on dependencies between two data PDCP PDUs, such as via the sequence numbering of the dependent PDUs); implicitly via mapping (e.g., dependent data units mapped to the same QoS flow/DRB/LCH, etc.); and/or an explicit relationship between a primary data unit and a secondary data unit created by the WTRU (e.g., SDAP/PDCP) by assembling data (e.g., or type thereof) into different data units. A relationship may be detectable and/or visible, for example, via any one or more of the methods described herein (e.g., in-band marking, control PDU, via mapping, etc.).

The data unit(s) may go through one or more of the following (sub) layer(s) of the protocol stack. At the (sub) layers, dependencies may translate and/or be visible, for example, via any one or more of the following: SDAP, PDCP, RLC, MAC, and/or PHY.

Dependencies may translate and/or be visible via SDAP. For example, data units mapped to the same QoS flow may have dependencies. For example, there may exist dependencies between different QoS flows. The dependent QoS flows may be marked with a dependent marker.

Dependencies may translate and/or be visible via PDCP. For example, data units mapped to the DRB may have dependencies. For example, there may exist dependencies between different PDCP entities/DRBs. For example, a data unit ID indicated in PDCP header.

Dependencies may translate and/or be visible via RLC. In some examples, data units mapped to one RLC entity may have dependencies. In some examples, there may exist dependencies between data units mapped to different RLC entities.

Dependencies may translate and/or be visible via MAC. For example, data units mapped to the same LCH may have dependencies. For example, data units mapped to one or more designated LCHs may have dependencies. For example, a data unit ID may be indicated in a MAC header. For example, the MAC in the WTRU may receive information on dependencies.

Dependencies may translate and/or be visible via PHY. Dependencies may be known/tracked at the PHY sublayer, for example, via any one or more of the following ways: the HARQ process ID mapped to a TB and/or CBG; grants in a multi PUSCH CG; different CG configurations for data units or type/group thereof; a set of resources (e.g., grants, frequency resources) reserved for one data unit or type/group thereof; an ID for the data unit (e.g., PDU set ID); and/or an indicator (e.g., a ‘0’ indicating a repair PDU and a ‘1’ indicating a source PDU).

Dependencies may be known/tracked at the PHY sublayer via the HARQ process ID mapped to a TB and/or CBG. For example, a (e.g., one) TB may include (e.g., only) PDUs of a (e.g., one) data unit. For example, a (e.g., one) CBG may include (e.g., only) PDUs of a (e.g., one) data unit.

Dependencies may be known/tracked at the PHY sublayer via grants in a multi PUSCH CG. For example, (e.g., all) grants in a (e.g., one) CG occasion may include PDUs of a (e.g., one) data unit.

Dependencies may be known/tracked at the PHY sublayer via different CG configurations for data units or type/group thereof. For example, restrictions may allow (e.g., only) source data units to be mapped to the CG grants in a (e.g., one) CG configuration. For example, there may be a (e.g., one) CG configuration for source data units and a (e.g., one) CG configuration for repair data units.

Dependencies may be known/tracked at the PHY sublayer via a set of resources (e.g., grants, frequency resources) reserved for a (e.g., one) data unit or type/group thereof.

Dependencies may be known/tracked at the PHY sublayer via an ID for the data unit (e.g., PDU set ID). For example, there may be a mapping between a (e.g., one) TB and one or more data unit of the same type. For example, there may be a mapping between a (e.g., one) TB and one or more data unit that have inter-dependencies. The WTRU (e.g., PHY sublayer in WTRU) may receive the ID from the MAC sublayer in the WTRU.

Dependencies may be known/tracked at the PHY sublayer via an indicator (e.g., a ‘0’ indicating a repair PDU and a ‘1’ indicating a source PDU). An indicator may be included, for example, in the header of the data unit.

Dependency information at a (e.g., any) sublayer in the protocol stack may be received from a (e.g., any) sublayer above the sublayer. For example, PHY may receive dependency information from MAC. For example, MAC may receive dependency information from RLC, PDCP, and/or SDAP. For example, PDCP may receive dependency information from SDAP and/or upper/application layers.

A WTRU may identify dependencies/association between dependent data units at the PHY layer. In some examples, the PHY layer in a WTRU may use association and/or configuration information to ensure that information about an association between dependent data units is maintained, e.g., if/when mapping and transmitting TBs within the scheduled UL resources. For example, if/when mapping TBs to the scheduled UL resources, the PHY layer in the WTRU may ensure that the receiving entity can identify the dependencies/association between data units included across different TBs. In some examples, the PHY layer may be provided information (e.g., one or more explicit and/or implicit information) and/or indications from higher layer (e.g., MAC layer) regarding TBs that may include associated data units.

The PHY layer in a WTRU may be provided dependency/association information from a higher layer, for example, in one or more of the following ways: HARQ process IDs assigned to TBs that may include dependent/associated data units/PDUs; a resource grant assigned to TBs that may include dependent/associated data units/PDUs; a channel coding scheme assigned to TBs that may include dependent/associated data units/PDUs; and/or an (e.g., explicit) indication that may include dependent/associated data units/PDUs.

A WTRU may be provided dependency/association information via HARQ process IDs assigned to TBs that may include dependent/associated data units/PDUs. For example, the PHY layer in WTRU may be configured to identify TBs assigned with HARQ process ID belonging to one or more sets of HARQ process IDs reserved for TBs that may include associated data units/PDUs.

A WTRU may be provided dependency/association information via a resource grant assigned to TBs that may include dependent/associated data units/PDUs. For example, the PHY layer in WTRU may be configured (e.g., upon receiving an indication, such as via RRC, DCI, of a reserved/special resource grant for transmission (e.g., CG or DG . . . ) to identify that TBs mapped to the reserved/special resource grant are TBs that may include dependent/associated data units/PDUs. The resource mapping reserved for TBs that may include data units/PDUs with dependencies/association may be implemented, for example, in one or more of the following ways: mapping in the frequency domain (e.g., the PHY layer at the WTRU may configured to map TBs that may include dependent data units/PDUs on a reserved bandwidth part (BWP); mapping in the time domain (e.g., the PHY layer at the WTRU may configured to map TBs that may include dependent data units/PDUs on reserved transmission occasions within a multi-PUSCH CG period); and/or mapping in a spatial domain (e.g., the PHY layer at the WTRU may configured to map TBs that may include dependent data units/PDUs on reserved antenna ports).

A WTRU may be provided dependency/association information via a channel coding scheme assigned to TBs that may include dependent/associated data units/PDUs. For example, the PHY layer may receive an indication (e.g., from MAC) to employ a channel coding scheme and/or an error detection scheme (e.g., cyclic redundancy check), which may be (e.g., exclusively) reserved for use on TBs that may include dependent/associated data unites/PDUs.

A WTRU may be provided dependency/association information via an (e.g., explicit) indication that may include dependent/associated data units/PDUs. For example, the PHY layer may be provided with an (e.g., explicit) indication (e.g., via MAC header) on TBs that may include dependent/associated data units.

In some examples, the WTRU (e.g., SDAP/PDCP) may assign different subsets of data units (e.g., source and repair) to separate PDU sets. A WTRU may create a relationship (e.g., an explicit relationship) between the PDU sets, e.g., between a “primary data unit” (e.g., a source data unit) and a secondary data unit (e.g., a secondary data unit). That relationship may become a “restriction” in LCP for the “secondary data unit.” For example, the WTRU may transmit the secondary data unit (e.g., only) if the primary data unit has not been transmitted. For example, the WTRU may transmit the secondary data unit (e.g., only) if the primary data unit has been transmitted. In some examples, there may be a “tertiary data unit,” whose transmission may not necessarily impact the QoS. For example, enhancement data units may be transmitted on a best effort basis (e.g., if resources are available) but the QoS of the associated data unit (e.g., the source data unit that may be enhanced) may not be impacted if any or all of the enhancement data unit is not transmitted, e.g., because the source data unit may be considered as successfully received at the receiver if the source bits/packets of the source data unit are successfully received at the receiver. In some examples, a data unit may include one or more source bits/packets and one or more enhancement bits/packets. The source data unit may be considered as successfully received at the receiver if the source bits/packets of the source data unit are successfully received at the receiver, irrespective of whether any (e.g., all or a portion) of the enhancement bits/packets are transmitted and/or received.

A “primary data unit” may be interchangeably referred to (e.g., herein) as a first data unit. A “secondary data unit” may be interchangeably referred to (e.g., herein) as a second data unit.

A dependent data unit and/or group/component/type thereof (e.g., as described herein) may refer to a data unit and/or group/component/type thereof that may be dependent on another data unit and/or group/component/type thereof or a data unit and/or group/component/type thereof that another data unit and/or group/component/type thereof may be dependent on.

A WTRU may determine dependencies at lower layers. A WTRU may determine what data units to associate together (e.g., the data units to associate to each other, a second data unit to associate to a first data unit, a first data unit to associate to a second data unit, a third data unit to associate to a second and/or first data unit, etc.) based on any one or more of the following: reception of information on AL-FEC at SDAP/PDCP/MAC sublayer from the upper/application layers and/or arrival times of data units in the protocol stack.

A WTRU may determine what data units to associate together based on reception of information on AL-FEC at SDAP/PDCP/MAC sublayer from the upper/application layers.

For example, A WTRU may determine what data units to associate together based on reception of information via the selected QoS flow/DRB/LCH.

For example, a QoS flow may be configured to handle dependencies between data units. The WTRU may assume (e.g., or determine or receive an indication) that (e.g., all) data units associated with a QoS flow have dependencies, e.g., with other data units tagged to the same QoS flow.

For example, there may be dependencies between two or more QoS flows, e.g., dependencies between QoS flow 1 and QoS flow 2. The WTRU may assume (e.g., or determine or receive an indication) that there are dependencies between data units of QoS flow 1 and QoS flow 2. In some examples, the dependencies may be one to one, e.g., data unit 1 of QoS flow 1 may be dependent on data unit 1 of QoS flow 2 and/or data unit 2 of QoS flow 1 may be dependent on data unit 2 of QoS flow 2. In some examples, the dependencies may be many to one or one to many. For example, data units 1 and 2 of QoS flow 1 may be dependent on data unit 1 of QoS flow 2 and/or data units 3 and 4 of QoS flow 1 may be dependent on data unit 2 of QoS flow 2. For example, data units 1 and 2 of QoS flow 2 may be dependent on data unit 1 of QoS flow 1 and/or data units 3 and 4 of QoS flow 2 may be dependent on data unit 1 of QoS flow 2.

For example, a radio bearer may be configured to handle dependencies between data units. For example, one or more DRB(s) may be configured to handle dependencies between data units.

In some examples, a WTRU (e.g., SDAP in WTRU) may tag (e.g., all) dependent data units (e.g., from one or more QoS flows) to the one or more DRBs that may be configured to handle dependencies.

In some examples, (e.g., only) dependent data units may be mapped to the one or more DRBs that may be configured to handle dependencies.

In some examples, dependent data units may be mapped to the one or more DRBs that may be configured to handle dependencies. Other data units (e.g., non-dependent data units) may (e.g., also) be mapped to the same DRB(s).

For example, a DRB (e.g., DRB A) may be configured for data units mapped to a (e.g., one) QoS flow (e.g., QoS flow A) and another DRB (e.g., DRB B) may be configured for data units mapped to another QoS flow (e.g., QoS flow B). The dependencies (e.g., if there are dependencies between QoS flow A and QoS flow B) may be maintained via an association between DRB A and DRB B. For example, a WTRU may receive (e.g., from the NW) information on dependencies between DRB A and DRB B. For example, dependency information may indicate that (e.g., only) data units from QoS flow A may be mapped to DRB A. For example, dependency information may indicate that (e.g., only) data units from QoS flow B may be mapped to DRB B. For example, dependency information may indicate that (e.g., only) data units from QoS flow A with a certain QoS profile (e.g., delay budget, delay deadline, error rate, PDB, PER, PSDB, PSER) may be mapped to DRB A. For example, dependency information may indicate that (e.g., only) data units from QoS flow B with a certain QoS profile (e.g., delay budget, delay deadline, error rate, PDB, PER, PSDB, PSER) may be mapped to DRB B. For example, dependency information may indicate that the data units from QoS flow A with dependencies with other data units from QoS flow A may be mapped to DRB A. For example, dependency information may indicate that the data units from QoS flow A with dependencies with data units from QoS flow B may be mapped to DRB A.

For example, DRBs may be configured to handle dependencies and/or dependencies between DRBs may be handled (e.g., via one or more identifiers). For example, the WTRU may receive (e.g., from the NW) an indication that DRB 1 is configured to handle dependencies. For example, the WTRU may receive (e.g., from the NW) an indication of the identifiers. In an example, the WTRU may receive (e.g., from the NW) an indication that DRB 1 and DRB 2 are configured to handle dependencies (e.g., between two flows and/or data units). The WTRU may receive indication(s) of the identifiers for DRB 1 and DRB 2.

For example, a radio bearer may be configured to assume (e.g., configured with an assumption) that one or more (e.g., all) data units tagged to a QoS flow have dependencies, e.g., with other data units tagged to the same QoS flow.

In some examples, a WTRU may determine what data units to associate together based on reception of information (e.g., explicitly) via in-band marking (e.g., in packet header).

In some examples, a WTRU may determine what data units to associate together based on reception of information (e.g., explicitly) via separate PDU, e.g., PDCP control PDU conveying dependency info via a sequence number (SN).

A WTRU may determine what data units to associate together based on arrival times of data units in the protocol stack.

A WTRU may group data units. A WTRU may group data units, for example, based on information on dependencies (e.g., received from application or determined by the WTRU). A WTRU (e.g., SDAP/PDCP) may assign different subsets of data (e.g., source and repair packets) to separate data units and/or may create an explicit relationship between the data units, e.g., between a primary data unit (e.g., a source data unit) and a secondary data unit (e.g., a secondary data unit).

A relationship may include a framework. For example, a (e.g., one) data unit or type thereof may be carried in one transport vessel/path and another data unit or type thereof may be carried in another transport vessel/path. The transport vessel may refer, for example, to any one or more of the following: QoS flow (e.g., one QoS flow per data unit and/or type/group/component thereof); Radio bearer (e.g., one DRB per data unit and/or type/group/component thereof); Logical Channel Group (LCG) (e.g., one LCG per data unit and/or type/group/component thereof); Logical channel (LCH) (e.g., one LCH per data unit and/or type/group/component thereof); RLC entity (e.g., one RLC entity processing per data unit and/or type/group/component thereof); and/or A (e.g., new) transport vessel (e.g., a construct used in the L2 stack such that (e.g., all) data units and/or type/group/component thereof mapped/tagged to the transport vessel may be considered to have an association.

A WTRU may determine the trigger(s) to report scheduling information, e.g., to the NW. Triggers may include, for example, any one or more of the following: UL data becomes available for transmission; an amount of UL data larger than a (pre) configured threshold becomes available for transmission; a type of UL data becomes available for transmission; data of one or more characteristics/parameters becoming available for transmission; data tagged to one or more constructs becoming available for transmission; an indication from a higher/application layer; and/or a status of the system. A trigger to report scheduling information may be based on an uplink data (and/or a dependent data) becoming available for transmission based on any one or more of the criteria described in U.S. patent application Ser. No. 18/794,093, filed Aug. 5, 2024, (Attorney Docket No. 2024P00530 US), titled CONDITIONAL AVAILABILITY OF DATA FOR TRANSMISSION, the disclosure of which is herein incorporated by reference in its entirety.

A trigger to report scheduling information may be based on UL data becoming available for transmission, for example, according to at least one of the following: data becomes unconditionally available for further processing (e.g., L2 processing) and for transmission (e.g., legacy volume); data becomes conditionally available for further processing (e.g., L2 processing), but not for transmission until one or more (e.g., all) associated conditions are met; and/or data not yet available for further processing (e.g., L2 processing) and (e.g., thus) not ready for transmission. A trigger may become known to the WTRU, for example, based on an application-level indication of an additional data volume and/or upper layer signaling of a change in an applicable QoS level/configuration.

A trigger to report scheduling information may be based on an amount of UL data larger than a (pre) configured threshold becoming available for transmission.

A trigger to report scheduling information may be based on a type of UL data becoming available for transmission. A trigger may be based on, for example, one or more of the following types of UL data becoming available: system/control data that may be critical for a user plane service to work becoming available for transmission; source packets versus enhancement packets becoming available for transmission; low delay budget data units; mandatory versus non-mandatory packets; types of data units; data that may have an associated condition for availability and/or transmission (e.g., a dependency on the transmission status of another data unit); and/or data that may be associated with a condition for availability and/or transmission of another data unit.

A trigger to report scheduling information may be based on data of one or more characteristics/parameters becoming available for transmission. Characteristics/parameters may include, for example, one or more of the following: priority, importance, delay budget/bound (e.g., PSDB/PSDD/PDB), whether or not there are dependencies to other data, time to serve data in L2 stack, presence/absence of PDU set integrated handling indication (PSIHI) indicator, etc.

A trigger to report scheduling information may be based on data tagged to one or more constructs becoming available for transmission. A construct (e.g., that may become available for transmission) may include, for example, one or more of the following: data tagged to a channel, QoS flow, DRB, LCH, and/or LCG, and/or other (e.g., new) constructs that may be used in L2 for routing of data, etc.

A trigger to report scheduling information may be based on an indication from a higher/application layer. For example, a higher layer (e.g., SDAP, PDCP) releasing data that may be deemed to have no dependencies to other data units may constitute a trigger for the WTRU to report scheduling information to the NW. For example, a higher layer (e.g., SDAP, PDCP) determining that data is available for transmission may constitute a trigger for the WTRU to report scheduling information to the NW.

A trigger to report scheduling information may be based on a status of the system. For example, there may be a congestion status, e.g., in the presence of congestion. A smaller data volume becoming available for transmission (e.g., in a congestion situation) may trigger the WTRU to report scheduling information to the NW (e.g., versus in a non-congestion situation). Congestion may be measured by the WTRU (e.g., via buffer status monitoring at the WTRU) and/or indicated to the WTRU from the NW. For example, there may be a radio link quality status, e.g., with a poor link quality. A smaller data volume becoming available for transmission may trigger the WTRU to report scheduling information to the NW (e.g., versus with a good link quality). For example, there may be a cell edge WTRU status versus a cell center WTRU status, etc.

A WTRU may determine the content to report. A WTRU may report scheduling information to the NW, which may include information on the data content and/or delay associated with the data content and/or additional information.

A WTRU may report (e.g., as a minimum, one bit) “up/down,” e.g., per radio bearer, LCH, PDU set, PDU set type, or (e.g., more generally) “flow” and/or same QoS treatment. The (e.g., at least one) bit reported may be interpreted, for example, by a discrete change in applicable QoS “agreement” and/or a step increase/decrease in amount of data to be scheduled. In some examples, the (e.g., one bit reported) may be transmitted in an SR. In some examples, a BSR may include the up/down indication, e.g., standalone or together with other content (e.g., any of the content as described herein). In some examples, the report (e.g., bit) for up/down may indicate if the other field is “held data” or “discarded data.”

A WTRU may report data content. A WTRU may transmit uplink scheduling information, which may include information on data for the purpose of scheduling transmission resources. The WTRU may determine what information to include in the uplink transmission (e.g., in a report), for example, according to at least one of the following: data volume; time information/latency requirement; jitter requirements; indication that data has become available for transmission; indication that data of (e.g., certain) type has become available for transmission; data volume/amount according to the data volume calculation; data volume/amount/percentage of entire data unit that has become available for transmission; data volume/amount/percentage of entire data unit in the WTRU buffer; data that previously became available for transmission; data that the WTRU anticipates may become available; data of an (e.g., a certain) amount/volume larger than a configured amount has become available for transmission; data of a (e.g., certain) percentage larger than a (e.g., configured) percentage amount has become available for transmission; data of a (e.g., certain) data unit type has become available for transmission; data that has become available for transmission after being withheld by the WTRU for a time; data that may not be available for transmission yet; data that may be dependent on other data (e.g., as described herein); and/or data that any other data (e.g., as described herein) may be dependent on.

A WTRU may determine what information to report (e.g., for scheduling transmission resources) according to data volume, which may include, for example, one or more of the following: data that may be unconditionally available for transmission; data that may be conditionally available for transmission; and/or data that may not be available for transmission, but could be generated and/or L2 processing (e.g., under one or more circumstances). The circumstances may include, for example, at least one of the following: data may become available within an (e.g., a specific) amount of time; and/or data may become available as a function of a different QoS/service level for scheduling resources of an uplink data transmission.

A WTRU may determine what information to report (e.g., for scheduling transmission resources) according to time information/latency requirement. A WTRU may include timing information related to the conditional availability of the data volume reported e.g., minimum time before which the WTRU may determine that the condition(s) may be met.

A WTRU may determine what information to report (e.g., for scheduling transmission resources) according to jitter requirements. A WTRU may report data volume as a function of a respective jitter requirement.

A WTRU may report an indication that data has become available for transmission for scheduling transmission resources. For example, a WTRU may report that the WTRU has in a buffer data available for transmission, e.g., without including the amount/volume of data.

A WTRU may determine what information to report (e.g., for scheduling transmission resources) according to an indication that data of (e.g., certain) type has become available for transmission. For example, a WTRU may report that the WTRU has in a buffer mandatory/system packets available for transmission, e.g., without including the amount/volume of data.

A WTRU may determine what information to report (e.g., for scheduling transmission resources) according to a data volume/amount according to the data volume calculation.

A WTRU may determine what information to report (e.g., for scheduling transmission resources) according to a data volume/amount/percentage of a (e.g., an entire) data unit that has become available for transmission.

A WTRU may determine what information to report (e.g., for scheduling transmission resources) according to a data volume/amount/percentage of a (e.g., an entire) data unit in the WTRU buffer.

A WTRU may determine what information to report (e.g., for scheduling transmission resources) according to data that previously became available for transmission, e.g., within a time window.

A WTRU may determine what information to report (e.g., for scheduling transmission resources) according to data that the WTRU anticipates may become available, e.g., within an upcoming time window.

A WTRU may determine what information to report (e.g., for scheduling transmission resources) according to data of an (e.g., a certain) amount/volume larger than a configured amount has become available for transmission.

A WTRU may determine what information to report (e.g., for scheduling transmission resources) according to data of a (e.g., certain) percentage larger than a (e.g., configured) percentage amount that has become available for transmission (e.g., more than 90% of packets within a data unit are available for transmission).

A WTRU may determine what information to report (e.g., for scheduling transmission resources) according to data of a (e.g., certain) data unit type that has become available for transmission.

A WTRU may determine what information to report (e.g., for scheduling transmission resources) according to data that has become available for transmission after being withheld by the WTRU for a time (e.g., data that has been made available within a time t ms, where t may be less than a preconfigured threshold).

A WTRU may determine what information to report (e.g., for scheduling transmission resources) according to data that may not be available for transmission yet (e.g., data that may become available for transmission in an upcoming time window).

A WTRU may determine what information to report (e.g., for scheduling transmission resources) according to data that may be dependent on any other data, e.g., as described herein.

A WTRU may determine what information to report (e.g., for scheduling transmission resources) according to data that any other data (e.g., as described herein) may be dependent on.

A data volume may be calculated and/or reported, for example, per radio bearer, logical channel, logical channel group (e.g., legacy), per group of PDUs, per PDU set, per group of PDU sets, per impact to the QoE level of the service, etc. Grouping may be a configuration aspect of the WTRU and/or may be based on awareness of the application data generated.

A data volume may be calculated and/or reported for a condition, for example, based on another volume of data, or type thereof. For example, data for a media coding enhancement layer may be reported as conditional to another amount of data. The report may be provided in separate fields of the control information (e.g., a MAC PDU), e.g., a buffer status field and a conditional buffer status field for the concerned data volumes. The fields and associated condition may be a configuration aspect of the WTRU.

A data volume may be calculated and/or reported for a condition, for example, based on the scheduling of resources for uplink transmission, or configuration thereof. For example, data amounts that may be necessary to probe, or to fulfill, a higher level of application-level QoE/QoS may be reported as conditional but not available. For example, data amounts that may correspond to application-level FEC e.g., beyond the minimal amount that may be necessary for successful reception. The condition may be related to a plurality of other data volumes to be (e.g., first) scheduled for uplink transmission, for example, on a reconfiguration of the QoS parameters and/or an observation/update of the applicable QoS parameters. The data volume may be reported as a data rate, and/or with an applicable time information/period for the data volume to be transmitted. Type and/or category may be reported, e.g., for QoS parameters associated with the data volume. Type and/or category may be reported in separate fields of the control information (e.g., a MAC PDU), e.g., a conditional buffer status field for the concerned data volume.

In some example realizations, a WTRU may receive downlink control information that may be interpreted as a positive acknowledgement of the data volume to be scheduled within a period of time. The period may be indicated in the control information. The WTRU may (e.g., additionally and/or alternatively) receive downlink control information that may be interpreted as a negative acknowledgement, e.g., that the WTRU may not multiplex the data for the transmission of new transport blocks. The WTRU may not multiplex the data for the concerned period. The WTRU may not multiplex the data, for example, unless padding would otherwise be transmitted by the WTRU. The WTRU may determine that the data should (e.g., thus) not be generated and/or be made available for transmission. The WTRU may be configured to not report the amount of data for a (e.g., minimum) period. For example, the WTRU may be configured with a prohibit timer that may be started upon determination that the WTRU may not multiplex the data (e.g., reception of control information that may be interpreted as a negative acknowledgement). The WTRU may (e.g., next) calculate and/or report the amount of data, e.g., no earlier than the period has elapsed (e.g., the timer has expired).

In some examples, a WTRU may report on a dependent data content. A WTRU may determine the data content to report when reporting scheduling information to the NW, for example, if there are dependencies between data A and data B. A report on dependent data content may include, for example, any one or more (e.g., a combination) of the following: an indication that a dependent data has become available for transmission; an indication that data of a (e.g., certain) type has become available for transmission; a data volume/amount according to the data volume calculation; a data volume/amount/percentage of a (e.g., an entire) data unit that has become available for transmission; a data volume/amount/percentage of a (e.g., an entire) data unit in the WTRU buffer; data that previously became available for transmission, e.g., within a time window; data that the WTRU anticipates may become available, e.g., within an upcoming time window; data of an amount/volume larger than a configured amount has become available for transmission; data of a percentage larger than a configured percentage amount has become available for transmission; data of a (e.g., certain) data unit type has become available for transmission; data that has become available for transmission after being withheld by the WTRU for a time; data that may not be available for transmission yet; data that may be dependent on other data (e.g., as described herein); and/or data that any other data (e.g., as described herein) may have dependencies with.

A report on dependent data content may include an indication that a dependent data has become available for transmission. For example, a report may indicate that the WTRU has in a buffer data B available for transmission, e.g., without including the amount/volume of data B. For example, data A may have already been multiplexed in a MAC PDU.

A report on dependent data content may include an indication that data of a (e.g., certain) type has become available for transmission. For example, a report may indicate the WTRU has in its buffer an enhancement packet available for transmission, e.g., without including the amount/volume of data. The WTRU may have already transmitted the associated source packet, for example.

A report on dependent data content may include a data volume/amount according to the data volume calculation. For example, a report may indicate the data volume associated with data B. In some examples, the data volume may include the volume of both data A and data B, e.g., if the WTRU has not yet transmitted any scheduling information on data A to the network. In some examples, the WTRU may transmit the aggregate volume of data A and data B. In some examples, the WTRU may transmit in an (e.g., one) indication (e.g., in one BSR) two data volumes, e.g., the data volumes of data A and data B without aggregation.

A report on dependent data content may include a data volume/amount/percentage of a (e.g., an entire) data unit that has become available for transmission. For example, a report may indicate a percentage of data B that has become available for transmission with respect to the entire size of data B.

A report on dependent data content may include a data volume/amount/percentage of a (e.g., an entire) data unit in the WTRU buffer. For example, a report may indicate a percentage of data B with respect to size of entire data B that is in the WTRU buffer. For example, a report may indicate a percentage of data with respect to size of data A and data B that is in the WTRU buffer).

A report on dependent data content may include data that previously became available for transmission, e.g., within a time window. For example, data B may not have been available for transmission for a time and became available for transmission within a time window that just passed. The WTRU may send an indication to the NW on data B, e.g., including any one or more of the following: an indication that data B has become available for transmission, an indication of when data B became available for transmission, volume of data B, time duration data B was held, dependency/relational information on data associated with data B, such as information for data A (e.g., as described herein), etc.

A report on dependent data content may include data that the WTRU anticipates may become available, e.g., within an upcoming time window. For example, the WTRU may have transmitted data A. The WTRU may expect to receive dependent data B in a time period, e.g., within the next 10 ms. The WTRU may send or may have already sent an indication to the NW on data B, e.g., including any one or more of the following: an indication that data B may become available for transmission, an indication of when data B may become available for transmission, an expected volume of data B, dependency/relational information on data associated with data B, such as information for data A (e.g., as described herein), etc.

A report on dependent data content may include data of an amount/volume larger than a configured amount has become available for transmission. For example, a report may indicate eight (8) bits or higher of data B with respect to entire size of data B (e.g., 10 bits) has become available for transmission. For example, a report may indicate eight (8) bits or higher with respect to an aggregate size of data A and data B (e.g., 20 bits) has become available for transmission.

A report on dependent data content may include data of a percentage larger than a configured percentage amount has become available for transmission. For example, a report may indicate more than 90% of packets within data B are available for transmission. For example, a report may indicate more than 90% of packets with respect to the aggregate size of data A and data B (e.g., 20 bits) have become available for transmission.

A report on dependent data content may include data of a (e.g., certain) data unit type has become available for transmission. For example, a report may indicate data B has become available for transmission. For example, a report may indicate source packets of data B have become available for transmission. For example, a report may indicate repair packets of data B with a delay budget lower than a preconfigured threshold have become available for transmission.

A report on dependent data content may include data that has become available for transmission after being withheld by the WTRU for a time. For example, a report may indicate data B that has been made available within a time t ms, where t may be less than a (pre) configured time.

A report on dependent data content may include data that may not be available for transmission yet. For example, a report may indicate data B or part thereof that may become available for transmission in an upcoming time window.

A report on dependent data content may include data that may be dependent on other data (e.g., as described herein). For example, a report may indicate data A and/or an (e.g., any) attribute of data A, e.g., volume of data A, status of data A (e.g., whether or not data A is available for transmission, when will data A become available for transmission if data A is currently not available, time duration data A was/is being/will be held, etc.), dependency/relational information on data A/data A with respect to data B (e.g., data B may be an enhancement layer to data A).

A report on dependent data content may include data that any other data (e.g., as described herein) may have dependencies with.

In any one or more of the examples described herein, the status of data A may be, for example, any one or more of the following: has not been received by the WTRU (e.g., from higher/application) layers; has not yet been received by the WTRU (e.g., from higher/application) layers; expected to be received by the WTRU (e.g., from higher/application) layers within a (pre) configured upcoming time window, e.g., based on traffic periodicity information, indication from application, etc.; in any one or more of the WTRU buffers (e.g., SDAP buffer, PDCP buffer, RLC buffer, MAC buffer, etc.); is being held in any one or more of the protocol stack buffers (e.g., SDAP buffer, PDCP buffer, RLC buffer, MAC buffer, etc.); has been multiplexed into a MAC PDU; already transmitted to the gNB; WTRU is waiting to receive an indication of successful reception of data A from the gNB; WTRU has received an indication of successful reception of data A from the gNB; WTRU has received an indication of successful reception of part of data A from the gNB; and/or WTRU has not received an indication of no/unsuccessful/corrupted reception of data A from the gNB (e.g., no HARQ NACK was received).

In some examples, a WTRU may send (e.g., only) scheduling information on data B, for example, if one or more (e.g., all) conditions related to data A are met. This may include, for example, any one or more of the following: WTRU has already transmitted data A (e.g., WTRU may transmit a BSR on data B (e.g., only) if the WTRU has already transmitted data A); WTRU has received a grant to transmit data A to the gNB (e.g., WTRU may transmit a BSR on data B (e.g., only) if the WTRU has received a grant to transmit data A, and/or, e.g., WTRU may send an indication alongside data A and/or append a BSR on data B alongside the TB with data A); WTRU has received data A (e.g., from higher/application) layers (e.g., WTRU may transmit a BSR on data B (e.g., only) if the WTRU has received data A in a buffer from the higher/application layers); WTRU has not received data A (e.g., from higher/application) layers); WTRU is expecting to receive data A (e.g., from higher/application layers) within a preconfigured upcoming time window, e.g., based on traffic periodicity information, indication from application, etc.; data A is in any one or more of the WTRU buffers (e.g., SDAP buffer, PDCP buffer, RLC buffer, MAC buffer, etc.); data A is being held in any one or more of the protocol stack buffers (e.g., SDAP buffer, PDCP buffer, RLC buffer, MAC buffer, etc.); data A has been multiplexed into a MAC PDU; data A is already transmitted to the gNB; WTRU is waiting to receive an indication of successful reception of data A from the gNB; WTRU has received an indication of successful reception of data A from the gNB; WTRU has received an indication of successful reception of part of data A from the gNB; WTRU has not received an indication of no/unsuccessful/corrupted reception of data A from the gNB (e.g., no HARQ NACK was received); and/or an FEC metric of data A has been fulfilled (e.g., the WTRU may transmit a BSR with information on data B if data A is a source packet, data A has been successfully delivered to the gNB, and there is a dependency between data A and data B).

In some examples, a WTRU may send scheduling information on data B (e.g., only) if one or more (e.g., some or all) conditions related to data B are met. The conditions may include, for example, any one or more of the following: an attribute of data B is met; the WTRU has not yet received a grant to transmit data B; the WTRU has not yet received a grant sufficiently large to transmit data B; and/or the WTRU has not yet received a grant sufficiently large to transmit data B and the dependent data A.

A WTRU may send scheduling information on data B (e.g., only) if an attribute of data B is met, such as one or more of the following, for example: PSI of data B>a preconfigured threshold; data type of data B is a mandatory packet; remaining time for data B<a preconfigured threshold; delay budget of data B<a preconfigured threshold; priority of data B>a preconfigured threshold; size of data B>a preconfigured threshold; number of packets in data B>a preconfigured threshold; whether an FEC metric is achieved via transmission of data B; and/or whether a QoS and/or QoE metric is improved via transmission of data B.

An attribute of data B may be met, for example, if an FEC metric is achieved via transmission of data B.

An FEC metric may be, for example, if N out of K packets have to be successfully received at the receiver for the FEC ratio to be met. For example, if data B is in the N packets, the WTRU may send a BSR with information on data B. If data B is in the remaining (K−N) packets, the WTRU may not send a BSR with information on data B.

An FEC metric may be, for example, if N out of K packets have to be successfully received at the receiver for the FEC ratio to be met. For example, if data B is the first N packets, the WTRU may send a BSR with information on data B. If data B is (N+m)^{th} (where m≥1) packets, the WTRU may not send a BSR with information on data B.

An FEC metric may be, for example, if all source packets have to be successfully received at the receiver for the FEC ratio to be met. For example, if data B is a source data unit, the WTRU may send a BSR with information on data B. If data B is not a source data unit (e.g., if data B is a repair and/or enhancement data unit), the WTRU may not send a BSR with information on data B.

An FEC metric may be, for example, if all source packets have to be successfully received at the receiver for the FEC ratio to be met. For example, if data B contains some source packets and/or some source bits, the WTRU may send a BSR with information on data B. The BSR may include information on the entire data B and/or only on the source bits/packets of data B.

An attribute of data B may be met, for example, if a QoS and/or QoE metric is improved via transmission of data B. A QoS and/or QoE metric may be improved via transmission of data B. The WTRU may be configured to not send a BSR with information on data B, for example, if data B is an enhancement data unit transmitted opportunistically if/when the WTRU has resources to do so, such that transmission of data B may not necessarily improve the overall QoS/QoE of the experience.

A WTRU may send scheduling information on data B, for example, (e.g., only) if the WTRU has not yet received a grant to transmit data B.

A WTRU may send scheduling information on data B, for example, (e.g., only) if the WTRU has not yet received a grant sufficiently large to transmit data B.

A WTRU may send scheduling information on data B, for example, (e.g., only) if the WTRU has not yet received a grant sufficiently large to transmit data B and the dependent data A.

A WTRU may report delay/time information. A WTRU may report on delay associated with any one or more data (e.g., as described herein) if/when reporting scheduling information to the NW. A report may include, for example, any one or more (e.g., a combination) of the following: delay budget/bounds associated with a data unit that the WTRU is reporting to the NW; delay budget/bounds associated with another data that the WTRU is not (e.g., necessarily) reporting to the NW; remaining time associated with data unit; remaining time associated with a data unit and/or component/type/group thereof; remaining time associated with another data unit; remaining time associated with a data unit and/or component/type/group thereof that is not yet available for transmission; time anticipated in protocol stack; delay budget/bounds associated with a data and/or group/component/type thereof that the WTRU is reporting to the NW; delay budget/bounds associated with a data and/or group/component/type thereof that the WTRU is reporting to the NW; delay budget/bounds associated with a data and/or group/component/type thereof that the WTRU is reporting to the NW; time duration for withholding data unit and/or component/part/group thereof; and/or delay budgets/bounds associated with the Round Trip time (RTT) of a data unit.

A report may include, for example, delay budget/bounds associated with a data unit that the WTRU is reporting to the NW. Delay budget/bounds associated with a data unit may include, for example, delay budgets e.g., packet delay budget (PDB), PDU set delay budget (PSDB), PDY set delay deadline (PSDD), etc. Delay budget/bounds associated with a data unit may include, for example, “no later than” to define a time bound for when the data can be scheduled. Delay budget/bounds associated with a data unit may include, for example, “no later than” to define a time bound for when a dependent data can be scheduled. Delay budget/bounds associated with a data unit may include, for example, delay budget/bounds associated with a data unit, e.g., provided the delay budget/bound value is below a (pre) configured threshold.

A report may include, for example, delay budget/bounds associated with another data that the WTRU is not (e.g., necessarily) reporting to the NW. For example, the WTRU may report at a later time a delay budget associated with a data that it previously reported to the NW. For example, the WTRU may report on the delay budget/bounds associated with a dependent data unit or part/component/group thereof. For example, the WTRU may report on the delay budget/bounds associated with a data unit or part/component/group thereof that is not (yet) available for transmission.

A report may include, for example, remaining time associated with data unit. For example, remaining time may be remaining time with respect to the associated delay budget (PDB/PSDB/PSDD). For example, a delay budget may be, may include, or may be based on time already spent in WTRU buffer.

A report may include, for example, remaining time associated with a data unit and/or component/type/group thereof, e.g., provided the remaining time value is below a (pre) configured threshold.

A report may include, for example, remaining time associated with another data unit, e.g., a data unit not (yet) available for transmission, a data unit having dependencies with the data unit in the WTRU buffer, etc. For example, remaining time associated with another data unit may be remaining time with respect to the associated delay budget of the other data unit (PDB/PSDB/PSDD of the other data unit). For example, a delay budget may be, may include, or may be based on time already spent in WTRU buffer. For example, a delay budget may be, may include, or may be based on jitter, e.g., in cases where the data unit not (yet) available for transmission may be experiencing some jitter.

A report may include, for example, remaining time associated with a data unit and/or component/type/group thereof that is not yet available for transmission, e.g., provided the remaining time value is below a (pre) configured threshold.

A report may include, for example, time anticipated in a protocol stack. For example, time anticipated in a protocol stack may be, may include, or may be based on time that the data unit is expected to spend in the L2 stack, e.g., based on knowledge of processing times at the different sublayers, e.g., PDCP (pre) processing, MAC processing, etc. In some examples, time anticipated in a protocol stack may be reported for a data unit available for transmission. In some examples, time anticipated in a protocol stack may be reported for a data unit not available for transmission. In some examples, time anticipated in a protocol stack may be reported for a data unit having dependencies with a data unit available for transmission or with a data unit not available for transmission. For example, time anticipated in a protocol stack may be, may include, or may be based on time that the other data unit (e.g., another data unit having dependencies with the data unit) is expected to spend in L2 stack, e.g., based on knowledge of processing times at the different sublayers, e.g., PDCP (pre) processing, MAC processing, etc.

A report may include, for example, delay budget/bounds associated with a data and/or group/component/type thereof that the WTRU is reporting to the NW, e.g., provided the WTRU did not previously report any delay budget/bounds associated with the data (e.g., to prevent overly frequent delay reporting).

A report may include, for example, delay budget/bounds associated with a data and/or group/component/type thereof that the WTRU is reporting to the NW, e.g., provided the WTRU did not report any delay budget/bounds associated with the data in a configured time window (e.g., in the last 10 seconds).

A report may include, for example, delay budget/bounds associated with a data and/or group/component/type thereof that the WTRU is reporting to the NW, e.g., provided the WTRU previously reported any delay budget/bounds associated with the data a number of times not exceeding a configured maximum number of times (e.g., a WTRU may be configured to report on delay budget/bounds associated with a data unit a maximum number of three (3) times).

A report may include, for example, time duration for withholding data unit and/or component/part/group thereof.

A report may include, for example, delay budgets/bounds associated with the Round Trip time (RTT) of a data unit.

A WTRU may report on additional information. The additional information a WTRU may report to the NW, may include, for example, one or more of the following: information on relational/dependencies between data unit; reason for withholding data unit and/or component/part/group thereof; indication of data that may have been discarded, e.g., due to unsuccessful reception of a dependent data unit; and/or an up/down indication, which may be interpreted by the gNB, for example, as a discrete change in applicable QoS “agreement” and/or a step increase/decrease in the amount of data to be scheduled.

A WTRU may report content to the NW based on a frequency of reporting content to NW. A WTRU may be configured with one or more prohibit timers to prevent overly frequent reporting of scheduling information to the NW. In some examples, there may be one prohibit timer for reporting of any scheduling information. In some examples, the WTRU may be configured with different prohibit timers, which may correspond, for example, to the different types of data that the WTRU may be reporting on, and/or the status of the data that the WTRU may be reporting on (e.g., data in WTRU buffer, data available for transmission, data not available for transmission, etc.).

A WTRU may report content to the NW, for example, in a Buffer Status Report (BSR), Delay Status Report (DSR), and/or Scheduling Request (SR). Content that the WTRU reports to the NW (e.g., as described herein) may be reported in any type of indication/message/request to the network, e.g., BSR, DSR, SR.

A WTRU may report content to the NW, for example, in a BSR. A WTRU may determine the amount of UL data available for transmission, for example, based on the data available for transmission, which may be determined at any one or more of the L2 entities (e.g., MAC, RLC, PDCP, new layer, SDAP). In some examples, the determination of the UL data available for transmission may be performed (e.g., completely done) at the MAC. In some examples, the determination of the UL data available for transmission may be done partially or completely at a different/higher layer, e.g., and indicated to the MAC entity.

A BSR (e.g., as described herein) may signify any indication/request to the NW with scheduling information.

A WTRU may trigger a buffer status report (BSR) according to at least one of the following, which may be based on the data volume calculation: UL data, e.g., for a logical channel that may belong to an LCG, that becomes available to the WTRU (e.g., MAC entity); UL data, e.g., for a logical channel that may belong to an LCG, that becomes available for transmission to the WTRU (e.g., MAC entity); and/or a trigger condition tied to a dependent data.

A WTRU may trigger a BSR report based on UL data, e.g., for a logical channel that may belong to an LCG, that becomes available to the WTRU (e.g., MAC entity). There may be one or more other conditions for the trigger. For example, the UL data may belong to a logical channel with higher priority than the priority of a (e.g., any) logical channel including available UL data that may belong to a (e.g., any) LCG. For example, the logical channels that belong to an LCG may not include any available UL data. For example, the data may not (yet) be available for transmission, e.g., the data may be expected to become available for transmission in an upcoming time window. For example, the data may be dependent on another data that may be available for transmission. The WTRU (e.g., MAC entity) having knowledge of the data may constitute a trigger for the WTRU to send a BSR to the NW, for example, since the data may be expected to become available for transmission shortly (e.g., within a preconfigured time window).

In some examples, a BSR may be an indication of upcoming data that may become available for transmission. The BSR may or may not include additional information. Additional information may include, for example, one or more of the following: information on the expected data volume; time; additional conditions to make data available for transmission, etc.

A BSR may include information on the expected data volume.

A BSR may include time information. For example, time information may indicate a time that data may be expected to become available for transmission. For example, time information may indicate the remaining time with respect to the data delay budget/bounds, etc.

A BSR may include additional conditions to make data available for transmission. Additional conditions may, for example, be based on (e.g., tied to) any one or more of the following: a priority of the data; delay criticality of the data; dependencies with other data; and/or attributes of the other data with dependencies (e.g., delay criticality of dependent data, priority of dependent data, etc.).

In some examples, a WTRU may (e.g., be able to) transmit a BSR for a data not (yet) available for transmission (e.g., only) if any one or more additional conditions are met. Additional conditions may include, for example, one or more of the following: if a prohibit timer for BSR for data not available for transmission is not currently running; if the data volume of the data not available for transmission is less than and/or equal to a (pre) configured threshold; if the data volume of the data not available for transmission is more than and/or equal to a (pre) configured threshold; if the remaining time with respect to the delay budget of the data is less than a (pre) configured threshold, e.g., where advance knowledge of the data may be useful for the NW to be able to quickly provision resources for the data when it does become available for transmission; WTRU past records. For example, if the WTRU over-reported the amount of data expected to become available for transmission in past instances (e.g., in the last three (3) instances and/or in the last 10 seconds), the WTRU may not be allowed to transmit BSR for data not available for transmission, e.g., for a preconfigured time window or indefinitely. For example, the WTRU may receive from the NW a reconfiguration of the prohibit timer for BSR for data not available for transmission, e.g., to make the prohibit timer longer. In some examples, the NW may make the prohibit timer equal to infinity to prevent the WTRU from transmitting a BSR until the WTRU receives a reconfiguration of the prohibit timer value from the NW. For example, the NW may monitor how much of the resources the NW provisioned and allocated to the WTRU (e.g., based on the WTRU estimation of data that may become available for transmission) that ended up getting used, e.g., via the number and/or percentage of padding bits with respect to the total transport block size the WTRU may have used in the transport block. An (e.g., another) indication that the WTRU may be over-reporting the amount of data expected to become available for transmission may include the WTRU sending frequent indications of unused resources to the NW (e.g., via UTO-UCI and/or unused CG occasions, etc.).

A WTRU may trigger a BSR report based on UL data, e.g., for a logical channel that may belong to an LCG, that becomes available for transmission to the WTRU (e.g., MAC entity). There may be one or more other conditions for the trigger. For example, the UL data may belong to a logical channel with higher priority than the priority of a (e.g., any) logical channel including available UL data for transmission that belongs to a (e.g., any) LCG. For example, the logical channels that belong to an LCG may not include a (e.g., any) available UL data for transmission. For example, the WTRU (e.g., MAC entity) may determine that data has become available for transmission, the WTRU may make data available for transmission (e.g., release data that was being held), and/or the WTRU may receive an indication from higher/application layers that data has become available for transmission.

In some examples, holding of data may be at a higher layer (e.g., SDAP/PDCP/RLC). Release of the data may tie to a trigger condition for BSR. In some examples, releasing of data at a sublayer may imply routing the data to another sublayer, which may be an adjacent sublayer (e.g., SDAP sending data to PDCP) or a non-adjacent sublayer (e.g., PDCP may send data directly to MAC, such as in an RLC Transparent mode type of processing). In some examples, releasing of data at a sublayer may imply not “holding” the data anymore at any one or more sublayers. In some examples, releasing of data at a sublayer may imply completion of a function at the WTRU (e.g., completion of assignment of sequencing numbering at PDCP may signify a release of data). For example, releasing of data at a higher layer (e.g., SDAP) may trigger the WTRU (e.g., MAC) to transmit a BSR to the NW. For example, releasing of data at a higher layer resulting from completion of a function at the sublayer or another sublayer may trigger the WTRU to transmit a BSR to the NW. For example, expiry of a discard timer at a sublayer (e.g., discardTimer at PDCP) may trigger the release of the data.

In some examples, releasing of data at a higher layer (e.g., SDAP/PDCP), e.g., in addition to another condition being met, may trigger the WTRU to transmit a BSR to the NW. For example, a WTRU may be triggered to transmit a BSR to the NW if the discard timer corresponding to the data expires and the WTRU does not already have a grant available to transmit the data. For example, a WTRU may be triggered to transmit a BSR to the NW if the discard timer corresponding to the data expires and the grant size of the upcoming CG grant is not sufficiently large to fit in the entire data unit.

A trigger condition for the WTRU to transmit BSR may be tied to a dependent data. Any one or more conditions (e.g., as described herein) may be tied to a dependent data.

A WTRU (e.g., in any one or more of the examples described herein) may report data in a BSR that is for one activated cell group and/or multiple activated cell groups.

A WTRU may send a BSR MAC CE. A WTRU may indicate, e.g., in a MAC CE, for example, any one or more of the following: an indication of data available at the WTRU for transmission; an indication of more than one data available at the WTRU for transmission, e.g., data A and a dependent data B being available for transmission; a buffer size; multiple buffer sizes; and/or LCG(s) and/or LCH(s).

A WTRU may indicate, e.g., in a MAC CE, for example, an indication of data available at the WTRU for transmission.

A WTRU may indicate, e.g., in a MAC CE, for example, an indication of more than one data available at the WTRU for transmission, e.g., data A and a dependent data B being available for transmission.

A WTRU may indicate, e.g., in the MAC CE, for example, a buffer size. A Buffer Size field may identify the (e.g., total) amount of data that may be available, e.g., according to the data volume calculation procedure at PDCP, RLC, and/or MAC. In some examples, a buffer size indication may include only data that is available for transmission. In one solution, it may include data not available for transmission. In some examples, In some examples, a buffer size indication may include a mix of data available and not available for transmission. In some examples, a buffer size indication may represent a data volume across (e.g., all) logical channels of a logical channel group. In some examples, a buffer size indication, e.g., according to a data volume calculation, may be done after the MAC PDU has been built.

A WTRU may indicate, e.g., in a MAC CE, for example, multiple buffer sizes, e.g., one buffer size corresponding to data A and one buffer size corresponding to a dependent data B.

A WTRU may indicate, e.g., in a MAC CE, for example, LCG(s) and/or LCH(s). For example, the LCG(s) and/or LCH(s) may correspond to the one or more data in the WTRU buffer and/or upcoming data in the WTRU buffer.

One or more BSR MAC CE formats may differentiate between data in a WTRU buffer and data available for transmission.

A WTRU may report on one or more data volumes. For example, a WTRU may differentiate between data at different processing stages (e.g., data already in WTRU buffer, data available for transmission) when transmitting an indication to the NW (e.g., in a BSR MAC CE).

A WTRU may report on one or more data volumes, which may include, for example, one or more of the following: data in a WTRU buffer (e.g., according to the data volume calculation); data available for transmission (e.g., data that has (e.g., just) been made available for transmissions (e.g., after being withheld by the WTRU for a time), such as data that has been made available within a time t ms, where t may be less than a (pre) configured time); data that may not be available for transmission yet; data that may become available for transmission in an upcoming time window; data that may be dependent on other data (e.g., as described herein); and/or data that other data (e.g., as described herein) may be dependent on.

A report may indicate one or more reasons for withholding a subset of data. A report may indicate a time held.

In some examples, a WTRU may combine (e.g., all) data volumes (e.g., as described herein). A WTRU may send an aggregate data volume in a (e.g., one) BSR. In some examples, a WTRU may have different types of BSRs for different types of data, e.g., one BSR for data available for transmission and one BSR for upcoming data for transmission.

In some examples, there may be a (e.g., one) BSR MAC CE per each type of data that the WTRU may report on. In some examples, there may be a (e.g., one) BSR MAC CE format that allows differentiating between data available for transmission and data not available for transmission. Any one or more of the BSR MAC CE(s) may include fields, such as a field indicating a reason for withholding a subset of data.

A WTRU may send a DSR. A WTRU may trigger a delay status report (DSR), which may include time/delay information on the data unit to be reported and/or a dependent data unit. In some examples, a DSR may report (e.g., time/delay information) on a data available for transmission. In some examples, a DSR may report (e.g., time/delay information) on a data not available for transmission. The trigger conditions for triggering a DSR may be, for example, any one or more of the trigger conditions to trigger a BSR (e.g., as described herein). The content of a DSR may include, for example, any one or more of the content of a BSR (e.g., as described herein).

In some examples, a condition for triggering a DSR may be the same condition for triggering a BSR, e.g., with the addition of a time component. A time component may indicate, for example, if the remaining time of the data unit and/or type/group/component thereof is less than a configured threshold. A time component may indicate, for example, if the delay budget of the data unit and/or type/group/component thereof is less than a configured threshold.

In some examples, a WTRU may include in a DSR (e.g., all) the information included in the BSR. For example, a DSR may (e.g., also) include information on one or more data volumes. In some examples, a DSR may include (e.g., only) time/delay information, e.g., with the understanding that the time/delay information may be associated with information on the data volume reported in one or more BSRs that the WTRU may have already transmitted to the gNB and/or that the WTRU may transmit to the gNB (e.g., in the next grant).

In some examples, a WTRU may not send a BSR if the WTRU has already sent a DSR with the data volume and time/delay information. In some examples, a WTRU may not send a DSR if the WTRU has already sent a BSR with the data volume and time/delay information.

In some examples, a WTRU may send in a BSR and/or DSR (e.g., only) the differential information. For example, if data volume was sent in a BSR report, the WTRU may exclude data volume in the DSR. The DSR may include (e.g., only) other information, e.g., one or more of time/delay information, reason for withholding data, time duration for withholding, etc.

In some examples, a WTRU may transmit a (e.g., only one) delay information in a DSR, e.g., time/delay information for the data with the shortest delay is transmitted. In some examples, transmission of the DSR may be (e.g., further) based on (e.g., tied to) a condition. For example, a DSR may indicate time/delay information for the data with the shortest delay (e.g., only) if the time/delay value is less than a (pre) configured threshold (e.g., less than 5 ms).

In some examples, a WTRU may transmit one or more delay information in a DSR, e.g., time/delay information for the data with the (e.g., two) shortest delay(s). In some examples, transmission of the DSR may be (e.g., further) based on (e.g., tied to) a condition. For example, time/delay information for the data with the two shortest delay may be transmitted (e.g., only) if the time/delay values are less than a (pre) configured threshold (e.g., less than 5 ms). For example, if only one of the time/delay is less than the preconfigured threshold, the WTRU may include in the DSR time/delay information (e.g., only) for the data with time/delay value less than the threshold.

In some examples, there may be one or more DSR MAC CE formats to report on time/delay information, e.g., similar to the BSR MAC CE. In some examples, a (e.g., one) DSR MAC CE may include only one time/delay information. In some examples, a (e.g., one) DSR MAC CE may include multiple time/delay information.

A WTRU may send a scheduling request (SR). In some examples, a WTRU may trigger a scheduling request (SR) according to any one or more of the triggers/conditions for a BSR (e.g., as described herein).

In some examples, an SR may be transmitted to indicate that the WTRU has data to transmit, e.g., without information on the data volume and/or associated time/delay. The data that the WTRU transmits may be data available for transmission or data not available for transmission.

In examples, a device (e.g., a WTRU) may determine data associated with a transmission (e.g., an UL transmission). The WTRU may determine a dependency characteristic (e.g., conditionally available or unconditionally available) of the data. The dependency characteristic may be used to determine whether to report scheduling information associated with the data. The dependency characteristic may be used to determine a condition for reporting the scheduling information associated with the data.

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

1. A wireless transmit/receive unit (WTRU), comprising:
a processor configured to:
determine an association between first data and second data;
determine, based on the association between the first data and the second data, a triggering condition for reporting scheduling information associated with the second data, wherein the triggering condition is satisfied based on a transmission availability of the first data; and
report the scheduling information associated with the second data based on the satisfaction of the triggering condition.

2. The WTRU of claim 1, wherein the processor is further configured to:
determine an arrival of the second data, wherein the scheduling information associated with the second data is reported further based on the arrival of the second data.

3. The WTRU of claim 1, wherein the triggering condition is that the first data is available to be transmitted, the processor is further configured to determine that the second data is available to be transmitted based on the satisfaction of the triggering condition, and the scheduling information associated with the second data is reported based on the determination that the second data is available to be transmitted.

4. The WTRU of claim 3, wherein the first data is associated with a source data unit, the second data is associated with a repair data unit, the processor is further configured to generate the repair data unit based on the source data unit, and wherein the association between the first data and the second data indicates that the second data is repair data of the first data.

5. The WTRU of claim 1, wherein the triggering condition is a first triggering condition, and the processor is further configured to:
determine, based on the association between the first data and the second data, a second triggering condition for reporting the scheduling information associated with the second data, wherein the second triggering condition is satisfied based on a transmission status of the first data, wherein the scheduling information associated with the second data is reported further based on the satisfaction of the second triggering condition.

6. The WTRU of claim 5, wherein the processor is further configured to:
transmit the first data;
receive an indication that the first data is received; and
determine, based on the indication, the transmission status of the first data, wherein the transmission status indicates that the transmission of the first data is successful.

7. The WTRU of claim 1, wherein the first data is associated with a data unit, and the processor is further configured to:
receive an indication that a percentage of the data unit is received; and
determine a third triggering condition for reporting the scheduling information associated with the second data, wherein the third triggering condition is satisfied based on the percentage of the data unit being greater than a threshold value.

8. The WTRU of claim 7, wherein the processor is further configured to determine, based on the percentage of the data unit, an amount of data that is available to be transmitted, and wherein the scheduling information associated with the second data indicates the amount of data that is available to be transmitted.

9. The WTRU of claim 1, wherein the scheduling information associated with the second data is indicated in a buffer status report (BSR), a delay status report (DSR), or a scheduling request (SR).

10. The WTRU of claim 1, wherein the processor is further configured to determine at a medium access control (MAC) layer, a radio link control (RLC) layer, or a packet data convergence protocol (PDCP) layer of the WTRU, that the triggering condition for reporting the scheduling information associated with the second data is satisfied.

11. A method performed by a wireless transmit/receive unit (WTRU), comprising:
determining an association between first data and second data;
determining, based on the association between the first data and the second data, a triggering condition for reporting scheduling information associated with the second data, wherein the triggering condition is satisfied based on a transmission availability of the first data; and
reporting the scheduling information associated with the second data based on the satisfaction of the triggering condition.

12. The method of claim 11, further comprising:
determining an arrival of the second data, wherein the scheduling information associated with the second data is reported further based on the arrival of the second data.

13. The method of claim 11, wherein the triggering condition is that the first data is available to be transmitted, the method further comprises determining that the second data is available to be transmitted based on the satisfaction of the triggering condition, and the scheduling information associated with the second data is reported based on the determination that the second data is available to be transmitted.

14. The method of claim 13, wherein the first data is associated with a source data unit, the second data is associated with a repair data unit, the method further comprises generating the repair data unit based on the source data unit, and wherein the association between the first data and the second data indicates that the second data is repair data of the first data.

15. The method of claim 11, wherein the triggering condition is a first triggering condition, and the method further comprises:
determining, based on the association between the first data and the second data, a second triggering condition for reporting the scheduling information associated with the second data, wherein the second triggering condition is satisfied based on a transmission status of the first data, wherein the scheduling information associated with the second data is reported further based on the satisfaction of the second triggering condition.

16. The method of claim 15, further comprising:
transmitting the first data;
receiving an indication that the first data is received; and
determining, based on the indication, the transmission status of the first data, wherein the transmission status indicates that the transmission of the first data is successful.

17. The method of claim 11, wherein the first data is associated with a data unit, and the method further comprises:
receiving an indication that a percentage of the data unit is received; and
determining a third triggering condition for reporting the scheduling information associated with the second data, wherein the third triggering condition is satisfied based on the percentage of the data unit being greater than a threshold value.

18. The method of claim 17, further comprising determining, based on the percentage of the data unit, an amount of data that is available to be transmitted, and wherein the scheduling information associated with the second data indicates the amount of data that is available to be transmitted.

19. The method of claim 11, wherein the scheduling information associated with the second data is indicated in a buffer status report (BSR), a delay status report (DSR), or a scheduling request (SR).

20. The method of claim 11, further comprising determining, at a medium access control (MAC) layer, a radio link control (RLC) layer, or a packet data convergence protocol (PDCP) layer of the WTRU, that the triggering condition for reporting the scheduling information associated with the second data is satisfied.
